(19) United States
(12) Patent Application Publication
(10) Pub. No.: US 2009/0183994 A1
(43) Pub. Date: Jul. 23, 2009

(54) PREPARATION OF NANO-TUBULAR TITANIA SUBSTRATE WITH OXYGEN VACANCIES AND THEIR USE IN PHOTO-ELECTROLYSIS OF WATER

(75) Inventors: Manoranjan Misra, Reno, NV (US); Krishnan Selva Raja, Sparks, NV (US); Susant Kumar Mohapatra, Reno, NV (US); Vishal Khamdeo Mahajan, Reno, NV (US)

Correspondence Address: NIXON PEABODY, LLP, 401 9TH STREET, NW, SUITE 900, WASHINGTON, DC, 20004-2128, US

(73) Assignee: UNIVERSITY OF NEVADA, RENO, Reno, NV (US)

(21) Appl. No.: 12/066,102

(22) PCT Filed: Sep. 11, 2006
(86) PCT No.: PCT/US06/35252

§ 371 Date: Dec. 10, 2008

Related U.S. Application Data
(60) Provisional application No. 60/715,163, filed on Sep. 9, 2005.
(60) Provisional application No. 60/749,639, filed on Dec. 13, 2005.
(60) Provisional application No. 60/750,335, filed on Dec. 15, 2005.
(60) Provisional application No. 60/794,853, filed on Apr. 26, 2006.

(51) Int. Cl. C25B 1/02; C25D 5/50; C25B 9/00; B32B 9/04; B32B 5/16

(52) U.S. Cl. 205/340; 205/224; 204/248; 428/702; 428/328; 977/734; 977/890

(57) ABSTRACT

The invention relates to a method of making a nanotubular titania substrate having a titanium dioxide surface comprised of a plurality of vertically oriented titanium dioxide nanotubes containing oxygen vacancies, including the steps of anodizing a titanium metal substrate in an acidified fluoride electrolyte and annealing the titanium oxide surface in a non-oxidating atmosphere. The invention further relates to a nanotubular titania substrate having an annealed titanium dioxide surface comprised of self-ordered titanium dioxide nanotubes containing oxygen vacancies. The invention further relates to a photo-electrolysis method for generating H₂ wherein the photo-anode is a nanotubular titania substrate of the invention. The invention also relates to an electrochemical method of synthesizing CdZn/CdZnTe nanowires, wherein a nanoporous TiO₂ template was used in combination with non-aqueous electrolyte. The invention also relates to a nanotubular titania substrate having CdTe or CdZnTe nanowires extending therefrom.

### RELATED APPLICATION DATA

This application claims priority to U.S. Provisional Patent Application No. 60/715,163, filed Sep. 9, 2005, U.S. Provisional Patent Application No. 60/749,639, filed Dec. 13, 2005, U.S. Provisional Patent Application No. 60/750,335, filed Dec. 15, 2005, and U.S. Provisional Patent Application No. 60/794,853, filed Apr. 26, 2006, the disclosures of which are hereby incorporated herein by reference in their entirety.

### FIELD OF THE INVENTION

This invention relates to hydrogen generation by photo-electrolysis of water with solar light using band gap engineered nano-tubular titanium dioxide photo-anodes. The titanium dioxide nanotubes are formed by anodization of a titania substrate in an acidified fluoride electrolyte, which may be conducted in the presence of an ultrasonic field or mixed by conventional mixing. The electronic band-gap of the titanium dioxide nanotubes is engineered by annealing in a non-oxidizing atmosphere yielding oxygen vacancies and optionally doping various elements such as carbon, nitrogen, phosphorous, sulfur, fluorine, selenium, etc. Reducing the band gap results in absorption of a larger spectrum of solar light, including the visible region, and therefore generates increased photocurrent leading to higher rate of hydrogen generation.

### BACKGROUND

Photoelectrolysis of water using visible light was first demonstrated by Fujishima and Honda with a single crystal rutile wafer. (See A. Fujishima and K. Honda, Nature 238 (1972) 37-38). Thermally or electrochemically oxidized Ti foils were used as anodes by the same authors in a subsequent paper and an energy conversion efficiency of more than 0.4% was observed. (See A. Fujishima, K. Kohayakawa and K. Honda, J. Electrochem. Soc., 122 (1975) 1487-1489). Recently Khan et al. demonstrated a maximum photoconversion efficiency of 8.35% using a chemically modified n-type TiO₂ film on Ti substrate. (See S. U. M. Khan, M. Al-Shahry, W. B. Ingel Jr., Science, 297 (2002) 2243-2245). The higher photoconversion efficiency was attributed to the lower bang gap energy (2.32 eV) of carbon doped n-TiO₂-xCx type film synthesized by combustion of Ti metal sheet, which absorbed light at wavelengths below 535 nm. Band gap narrowing was observed in nitrogen doped TiO₂ nano-particles also. (See R. Asahi, T. Morikawa, T. Ohwaki, K. Aoki, Y. Taga, Science 293 (2001) 269-271). Dye sensitized nano porous TiO₂ films are being extensively researched and higher efficiency is reported. (See U. Bach et al., Nature 395 (1998) 583-585).

Recent research focus is on nanocrystalline semiconductors to construct high efficiency photoelectrochemical cell. Nanocrystalline materials of tungsten trioxide, iron oxide and cadmium sulfide have been investigated as potential materials for solar water splitting. (See C. Santato, M. Ulmann and J. Augustynski, J. Phys. Chem., B105 (2001) 936-940, S. U. M. Khan, J. Akikusa, J. Phys. Chem. B103 (1999) 7184-7189, and G. Hodes, I. D. J. Howell, L. M. Peter, J. Electrochem. Soc., 139 (1992) 3136-3140). In these materials, charge separation is envisaged to occur at the semiconductor-electrolyte interface (by different rates of charge transfer to the solution) and not at the electrode as a space charge layer cannot be present at the electrode (each nano-crystal is an electrode) because of the size constraint. The type of semiconductivity of the nano-crystalline film is found to depend on the nature of the charge (hole or electron) scavenger present in the electrolyte. (See M. Gratzel, Nature 414 (2001) 338-344). By altering the dimensions of the nanomaterial, the quantum size effect is reported to be used to control the band gap and enhanced absorption coefficient has been observed due to quantum confinement. (See W. U. Huynh, J. J. Dittner, A. P. Alvisatos, Science 295 (2002) 2425-2427).

Al, Ti, Ta, Nb, V, Hf, W, Zr are all classified as “valve metals” because their surface is immediately covered with a native oxide film of a few nanometers when exposed to oxygen containing surroundings. These metals are widely used to synthesize their respective metal oxide nanotubes through anodization process (See G. P. Sklar, K. Paramguru, M. Misra and J. C. LaCombe, Nanotechnology, 16 (2005) 1265-1271., H. Tsuchiya, J. M. Macak, A. Ghicov, L. Taveira and P. Schmuki, Corrosion Science, 47 (2005) 3324-3335., I. Sieber, H. Hildebrand, A. Friedrich and P. Schmuki, Electrochem. Commun., 7 (2005) 97-100., and H. Tsuchiya, J. M. Macak, I. Sieber, L. Taveira, A. Ghicov, K. Sirotna and P. Schmuki, Electrochem. Commun., 7 (2005) 295-298.). Among all the different valve metals, there is great technological interest in titanium due to its versatility, which makes possible different applications. On the other hand, titanium oxide has many technologically relevant applications such as gas sensors, photovoltaics, photo and thermal catalysis, photoelectrochromic devices, and immobilization of biomolecules (See S. Liu and A. Chen, Langmuir, 21 (2005) 8409-8413., D. V. Bavykin, E. V. Milsom, F. Marken, D. H. Kim, D. H. Marsh, D. J. Riley, F. C. Walsh, K. H. El-Abiary and A. A. Lapkin, Electrochem. Commun., 7 (2005) 1050-1058., D. V. Bavykin, A. A. Lapkin, P. K. Plucinski, J. M. Friedrich and F. C. Walsh, J. Catal., 235 (2005) 10-17., K. S. Raja, M. Misra and K. Paramguru, Mater. Lett., 59 (2005) 2137-2141., S. Oh and S. Jin, Mater. Sci. Engg. C, 2006, in press., and K. S. Raja, V. K. Mahajan and M. Misra, J. Power Soursec, 2006, in press.).

Over the past several years preparation of nanoporous TiO₂ tubes by anodization process has the main attention of the scientific community due to its easy of handling and simple preparation method than the TiO₂ nanoparticles. Over the years, several electrolytic combinations are being used for the anodization of titanium (See J. Zhao, X. Wang, R. Chen and L. Li, Solid State Commun., 134 (2005) 705-710., C. Ruan, M. paulose, O. K. Varghese, G. K. Mor and C. A. Grimes, J. Phys. Chem. B, 109 (2005) 15754-15759., J. M. Macak, K. Sirotna and P. Schmuki, Electrochem. Acta, 50 (2005) 3679-3684., H. Tsuchiya, J. M. Macak, L. Taveira, E. Balaur, A. Ghicov, K. Sirotna and P. Schmuki, Electrochem. Commun., 7 (2005) 576-580., J. M. Macak, H. Tsuchiya and P. Schmuki, Angew. Chem. Int. Ed., 44 (2005) 2100-2102., and Q. Cai, M. Paulose, O. K. Varghese and C. A. Grimes, J. Mater. Res., 20 (2005) 230-236.).

Among the available photosensitive materials, TiO₂ semiconductors (anatase and rutile) are highly stable and relatively inexpensive. Therefore, titanium dioxide is considered potential material for photo-anodes. In general, nanocrystalline TiO₂ materials are typically synthesized through chemical route as powders and subsequently coated on a conductive substrate. The nanocrystalline anodes have been fabricated by coating TiO₂ slurry on conducting glass, spray pyrolysis, and layer by layer colloidal coating on glass substrate followed by calcinations at an appropriate temperature. (See J. van de Lagemaat, N.-G. Park, A. J. Frank, J. Phys. Chem. B104, (2000) 2044-2052). The disadvantages of these processes are: lower mechanical bond strength between glass substrate and TiO₂ coating, agglomeration of nanoparticles, poor control of coating parameters, poor electrical connectivity between particles etc. Further, it was suggested that instead of interconnected 3-D type nanoparticles, fabrication of vertical standing nanowires of TiO₂ could improve the photoconversion efficiency. (See S. U. M. Khan, T. Sultana, Solar Energy Materials & Solar Cells 76 (2003) 211-221). Anodization of titanium metal substrate in acidified fluoride solution results in formation of ordered arrays of TiO₂ nanotubes. These vertically oriented TiO₂ nanostructures have better mechanical integrity and photoelectric properties than those of TiO₂ nanocoating prepared by slurry casting route.

The photoelectrolysis properties of anodized titanium oxide nanotubes have previously been studied and reported. (See, for example, U.S. Patent Publication No. 2005/0224360 to Varghese et al.). These types of studies have reported the photoelectrolysis properties of anodized titanium oxide nanotubes having 22 nm diameter, 34 nm wall thickness and 224 nm long (See G. K. Mor, K. Shankar, M. Paulose, O. K. Varghese, C. A. Grimes, Nanoletters 5 (2005) 191-195). In addition, 6 micrometer long TiO₂ nanotubes have been shown to have less than 0.4% efficiency of water photoelectrolysis using simulated solar spectrum of light (AM 1.5) (see M. Paulose, G. K. Mor, O. K. Varghese, K. Shankar, C. A. Grimes, J. Photochem. Photobio. A: Chem. 178 (2006) 8-15).

Although research has addressed hydrogen generation by photoelectrolysis of water using visible light there remains a need for a more efficient and robust system for these processes. This invention answers that need through the use of novel nano-tubular titania substrates where the titanium dioxide nanotubes have the required band-gap for photo-electrolysis of water.

### SUMMARY OF THE INVENTION

The invention relates to a method of making a nanotubular titania substrate having a titanium dioxide surface comprised of a plurality of vertically oriented titanium dioxide nanotubes containing oxygen vacancies. The method preferably includes the steps of anodizing a titanium metal substrate in an acidified fluoride electrolyte under conditions sufficient to form a titanium oxide surface comprised of self-ordered titanium oxide nanotubes, and annealing the titanium oxide surface in a non-oxidating atmosphere. The non-oxidating atmosphere may be a reducing atmosphere, such as nitrogen, hydrogen, or cracked ammonia.

The method may further include the step of doping the titanium oxide surface with a Group 14 element, a Group 15 element, a Group 16 element, a Group 17 element, or mixtures thereof. The electrolyte preferably includes a fluoride compound selected from the group consisting of HF, LiF, Naf, KF, NH₄F, and mixtures thereof, and the electrolyte may be an aqueous solution, or an organic solution, such as a polyhydric alcohol selected from the group consisting of glycerol, EG, DEG, and mixtures thereof. The electrolyte may also be mixed by traditional magnetic stirring or may be ultrasonically stirred.

The invention further relates to a nanotubular titania substrate having an annealed titanium dioxide surface comprised of self-ordered titanium dioxide nanotubes containing oxygen vacancies. The nanotubular titania substrate preferably has a band gap ranging from about 1.9 eV to about 3.0 eV. In addition, the titanium dioxide nanotubes may be doped with a Group 14 element, a Group 15 element, a Group 16 element, a Group 17 element, or mixtures thereof, and may also be nitrogen doped, carbon doped, or both. The titanium dioxide nanotubes may also be further modified with carbon under conditions suitable to form carbon modified titanium dioxide nanotubes.

The invention also relates to a photo-electrochemical cell that uses the nanotubular titania substrate of the invention as an electrode. The invention further relates to a photo-electrolysis method for generating H₂ that includes the step of irradiating a photo-anode and a photo-cathode with light under conditions suitable to generate H₂, wherein the photo-anode is a nanotubular titania substrate of the invention. The light may be solar light. In addition, an acidic solution may be used in the photo-cathode compartment, and a basic solution may be used in the photo-anode compartment. The photo-cathode may be at least one substance selected from the groups consisting of a cadmium telluride (CdTe) coated platinum foil, a cadmium zinc telluride (CdZnTe) coated platinum foil, and anodized TiO₂ nanotubes coated with nanowires of CdTe or CdZnTe.

The invention further relates to an electrochemical method of synthesizing CdZn or CdZnTe nanowires comprising pulsing cathodic and anodic potentials to grow the nanowires, wherein a nanoporous TiO₂ template was used in combination with non-aqueous electrolyte. The non-aqueous electrolyte may be propylene carbonate. The invention also relates to a nanotubular titania substrate having CdTe or CdZnTe nanowires extending therefrom.

### BRIEF DESCRIPTION OF THE DRAWINGS

FIG. 1 shows an XPS spectrum of TiO₂ (annealed under N₂ atmosphere) in Ti₂ₚ region.

FIG. 2 illustrates a typical anodization apparatus and anodization time.

FIG. 3 illustrates how ultra sonicating the electrolyte during anodization aids in nanotube formation gives more uniform and smooth nanotubes than achieved with other mixing techniques.

FIG. 4 illustrates the affect on TiO₂ conduction band upon annealing in a reducing atmosphere.

FIG. 5 shows the differences in band gap before and after annealing according to the invention.

FIG. 6 is a schematic of laboratory scale arrangement of hydrogen generation setup using photo-electrochemical cell and solar light.

FIG. 7 is a schematic of an anodization set-up which may be used with the invention.

FIG. 8 is a field emission scanning electron microscopic (FESEM) image a top view of a nanoporous titanium surface after anodization.

FIG. 9 is a FESEM image of a side view of a nanoporous titanium surface after anodization.

FIG. 10 shows FESEM images of titanium oxide nanopores formed by anodization in a glycerol based electrolyte.

FIG. 11 shows FESEM images of titanium oxide nanopores formed by anodization in an ethylene glycol based electrolyte.

FIG. 12 shows SEM images of nano-tubular TiO₂ using EDTA and 0.5 wt % NH₄F.

FIG. 13 shows SEM images of the nano-tubular TiO₂ obtained using the following neutral aqueous solutions: (a) EG+0.5 wt % NaF, (b) H₂O+0.5 wt % NaF, (c) [H₂O+EG (1:1 volume ratio)]+0.5 wt % NaF, (d) [H₂O+EG (1:3 volume ratio)]+0.5 wt % NaF, and (e) cross sectional view of (c).

FIGS. 14-21 show FESEM images of titanium oxide nanopores formed under various conditions using ultrasonic-mediated anodization.

FIGS. 22-24 illustrate the results of photocurrent generated during solar light irradiation of various photo-anodes of the invention.

FIG. 25 shows the photoconversion efficiency, η, of the photo-anodes at different applied potentials.

FIG. 26 shows FESEM images of titanium oxide nanopores formed at various anodiazation times using ultrasonic-mediated anodization.

FIG. 27 shows SEM images of porous titanium oxide nanotubes (a) pore surface, (b) nanotubes, (c) barrier layer and (d) titanium surface.

FIG. 28 shows SEM images of titanium oxide nanotubes using magnetic stirring after (a) 1800 sec and (b) 2700 sec.

FIG. 29 is a current vs. time graph during anodization of Ti in phosphoric acid and sodium fluoride (a) magnetic stirring and (b) ultrasonic.

FIG. 30 shows SEM images of nano-tubular TiO₂ using 0.5M H₃PO₄ and 0.14M fluoride salt, (a) ammonium fluoride and (b) potassium fluoride.

FIG. 31 shows SEM images of ordered nanoporous TiO₂ tubes showing the effect of applied potential on the formation of nanotubes.

FIG. 32 shows SEM images of the results of anodization with (a) NaF (b) KF and (c) NH₄F.

FIG. 33 shows a current vs time plot during anodization of titanium in phosphoric acid and different fluoride medium (a) KF, (b) NH₄F and (c) NaF

FIG. 34 shows a plot of the photocurrent densities of NaF and NH₄F.

FIG. 35 shows SEM images of nano-tubular TiO₂ using ethylene glycol+0.5 wt % NH₄F solution prepared by (a) ultrasonic and (b) magnetic stirring.

FIG. 36 shows an XPS spectrum of ultrasonic-EG-TiO₂ nanotubular arrays showing mostly C is attached to the Ti as carbonate species.

FIG. 37 shows a plot of photoelectrochemical generation of hydrogen from water using various treated TiO₂ nanotubular arrays.

FIG. 38 shows a comparative absorption spectra of samples modified by deposition of carbon modified TiO₂ nanotubes.

FIG. 39 shows a typical C 1 s XPS spectrum of a carbon modified TiO₂ nanotubular sample.

FIG. 40 shows photocurrent-potential characteristics of annealed phosphate containing TiO₂ nanotubes illuminated only in the visible light having a center wavelength (CWL) at 520 nm and FWHM of 92 nm.

FIG. 41 shows the photocurrent results of carbon modified TiO₂ samples as a function of applied potential.

FIG. 42 shows the results of band-gap determination based on the photo current (Iₚₕ) values as a function of the light energy.

FIGS. 43-46 illustrates Mott-Schottky results showing the n-type behavior of TiO₂ nanotubes.

FIG. 47 illustrates a typical pulsed-potentials cycle contained two cathodic, two anodic and one open circuit potential.

FIG. 48 shows the nanoporous morphology of the anodized titanium template used for the growth of CdZnTe nanowires.

FIG. 49 shows the results of CV carried out in different non-aqueous solutions on the Pt surface.

FIG. 50 illustrates a cathodic current observed in CdTe solutions.

FIGS. 51 and 52 shows similarities between CVs of CdTe and ZnTe

FIG. 53 shows a CV of CdZnTe solution with varying amounts of Te.

FIGS. 54-56 shows the results of a CV carried out in CdZnTe solutions on a TiO₂ surface by switching the scan directions at various potentials.

FIG. 57 illustrates the anodic stripping characteristic of film deposited on TiO₂ at −0.7V at different times.

FIG. 58 shows the anodic stripping characteristic of film deposited at −1.0 V with different holding times.

FIG. 59 shows the growth of nanowires of CdZnTe from the anodized titanium dioxide templates after 1 minute of deposition.

FIG. 60 shows the growth of nanowires of CdZnTe after 30 minutes of deposition.

FIG. 61 shows the EDAX analysis done on the −0.4 V for 1 see, −0.6V for 1 sec samples.

FIG. 62 shows typical XRD result of CdZnTe nanowire deposit revealing Cd_{0.96}Zn_{0.04}Te stoichiometry in as-deposited condition.

FIG. 63 shows XRD peaks after annealing in argon at 350° C. for 1 hour.

FIGS. 64 and 65 show Mott-Schottky plots of CdZnTe nanowire deposits in the as-deposited and annealed conditions respectively.

FIG. 66 shows a Mott-Schottky plot for nanoporous TiO₂ template in as-anodized condition.

FIG. 67 shows the optical absorption spectra of nanotubular TiO₂ arrays anodized in a 0.5 M H₃PO₄+0.14 M NaF (i.e. phosphate) solution.

FIG. 68 shows a typical N 1 s XPS spectrum of the TiO₂ nanotubular sample anodized in nitrate solution and annealed in nitrogen atmosphere.

FIG. 69 shows a high resolution P 2 p XPS spectrum of phosphorous doped TiO₂ nanotubes.

### DETAILED DESCRIPTION OF THE INVENTION

This invention relates to hydrogen generation by photo-electrolysis of water with solar light using band gap engineered nano-tubular titania photo-anodes. The titania nanotubes are formed by anodization of a titanium metal substrate in an electrolyte. The electronic band-gap of the titania nanotubes is engineered by annealing in a non-oxidizing atmosphere yielding oxygen vacancies and optionally by doping with various elements such as carbon, nitrogen, phosphorous, sulfur, fluorine, selenium etc. Reducing the band gap results in absorption of a larger spectrum of solar light in the visible wavelength region and therefore generates increased photocurrent leading to higher rate of hydrogen generation.

Nano-Tubular Titania Substrates

The invention relates to a nano-tubular titania substrate having a surface comprised of self-ordered titania nanotubes. The term “self-ordered titania nanotubes” refers to a titania (a titanium dioxide) surface comprised of a plurality of vertically-oriented titania nanotubes, such as shown in FIG. 8, for example. Among the available photosensitive materials, TiO₂ is highly stable against photo corrosion and is relatively inexpensive. Traditional methods of forming TiO₂ nanocrystalline photo-anodes include coating titania slurry on conducting glass, spray pyrolysis, and layer by layer colloidal coating on glass substrate followed by calcinations at an appropriate temperature, each of which results in the formation of 3-D networks of interconnected nanoparticles. In contrast, the invention relates to vertical standing, self-ordered TiO₂ nanotubes which improve the photo conversion efficiency. These vertically oriented TiO₂ nanostructures will have better mechanical integrity and photoelectric properties than those of TiO₂ nanocoating prepared by slurry casting route. The main limitation of use of the TiO₂ material for photoelectrolysis is its wider band gap, which requires higher energy of light for photo excitation of electron-hole pairs. Therefore, only 3-5% of the solar light (UV-portion) can be used for conversion into photocurrent. Substitutional doping of elements like, for example, C, N, F, P or S in the oxygen sub-lattice has been considered to narrow the band gap because of mixing of the p states of the guest species with O 2 p states.

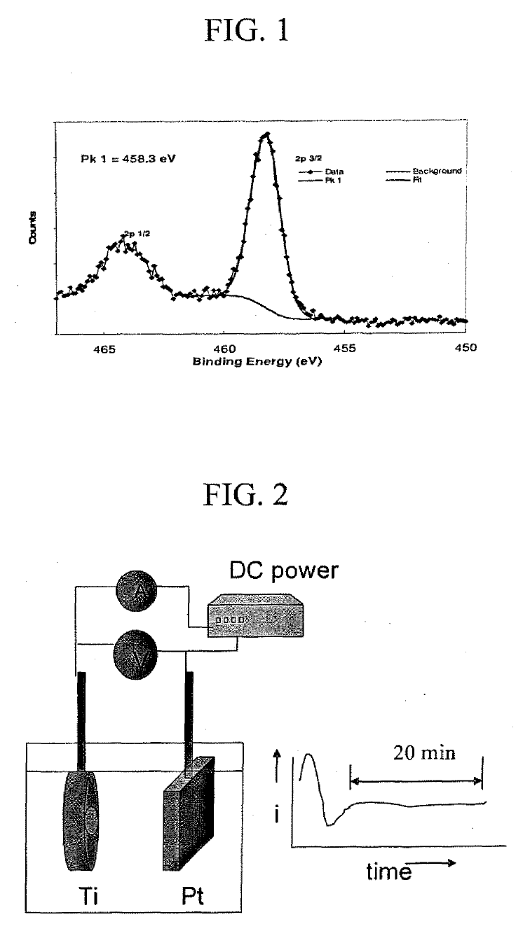

In addition, the self-ordered titania nanotubes of the invention contain oxygen vacancies. That is, the titania has non-stoichiometric amount of oxygen relative to titanium metal in its +4 oxidation state, Ti⁺⁴, although TiO₂ (Ti⁺⁴) is the predominant portion of the titania nanotubes. Creation of oxygen vacancies at the two-fold coordinate bridging sites in the titania nanotubes results in the conversion of Ti⁴⁺ to Ti³⁺. In other words, due to the oxygen vacancies, or non-stoichiometric amount of oxygen, in the titania, the titanium is present in its +4 and +3 oxidation states. This can also be viewed as the nanotubes of the titania surface comprising a combination of TiO₂ and Ti₂O₃ (i.e. TiO₂₋ₓ). FIG. 1 shows the XPS spectrum of a nano-tubular substrate (annealed under N₂ atmosphere) in Ti₂ₚ region. The titania nanotubes were formed by anodization in 0.5 M H₃PO₄+0.4 M NaF solution at 20 V for approximately 45 minutes followed by annealing in nitrogen atmosphere at 350° C. for 6 hours. The Ti⁴⁺ peak at 458.3 eV is asymmetric. The asymmetry reveals oxygen vacancies because the Ti⁴⁺ is not fully coordinated. Deconvolution of the XPS spectrum of FIG. 1 shows a small peak around 459.2 eV (Ti³⁺) is merged into the main peak (Ti⁴⁺).

Nano-tubular titania substrates of the invention are prepared by anodization of a titanium metal substrate in an acidified fluoride electrolyte to form a surface comprised of self-ordered titania nanotubes followed by non-oxidative annealing. Non-oxidative annealing includes annealing in vacuum and “reductive annealing”, annealing of the titanium dioxide nanotubes in a reducing atmosphere. This gives the nano-tubular titania substrate a band gap in the range of about 1.9 to about 3.0 eV. The nano-tubular titania substrates of the invention are useful in generating hydrogen by photo-electrolysis of water by solar light. The preferential band gap for effective photoelectrolysis of water is 1.6-2.1 eV.

Titanium Metal Substrates

Any type of titanium metal substrate may be used to form the nano-tubular titania substrates of the invention. The only limitation on the titanium metal substrate is the ability to anodize the titanium metal substrate or a portion thereof to form the titania nanotubes on the surface. The titanium metal substrate may be titanium foil, a titanium sponge or a titanium metal layer on an other substrate, such as, for example, a semiconductor substrate, plastic substrate, and the like, as known in the art. Titanium metal may be deposited on a substrate using conventional film deposition techniques known in the art, including but not limited to, sputtering, evaporation using thermal energy, E-beam evaporation, ion assisted deposition, ion plating, electrodeposition (also known as electroplating), screen printing, chemical vapor deposition, molecular beam epitaxy (MBE), laser ablation, and the like. The titanium metal substrate and/or its surface may be formed into any type of geometry or shape known in the art. For example, the titanium metal substrate may be planar, curved, tubular, non-linear, bent, circular, square, rectangular, triangular, smooth, rough, indented, etc. There is no limitation on the size of the titanium metal substrate. The substrate size depends only upon the size of the annodization tank. For example, sizes ranging from less than a square centimeter to up to square meters are contemplated. Similarly, there is no limit on thickness. For example, the titanium metal may be as thin as a few nanometers.

Annodization of the Titanium Metal Substrates

Anodization of titanium metal substrates to form a surface of titantium dioxide (titania) nantotubes is known in the art. (See, for example, K. S. Raja, M. Misra, and K. Paramguru, Electrochem. Acta, 51, (2005) 154-165; O. K. Varghese, C. A. Grimes, J. Nanosci. Nanotech, 3 (2003) 277; D. gong, C. A. Grimes, O. K. Varghese, W. Hu, R. S. Singh, Z. Chem. J. Mater, Res. 16 (2001), 3331; R. Beranek, H. Hildebrand, P. Schmucki, Eletrochem. Solid-State Lett. 6 (2003) B12; Q. Cai, M. Paulose, O. K. Varghese, C. A. Grimes, J. Mater. Res. 20 (2005) 230; J. M. Macak, H. Tsuchiya, p. Schmucki, Angew. Chem., Int. ed. 44 (2005) 2; WO/2006/004686; and US 2005/0224360 A1. Each of these is incorporated here by reference.) Phosphoric acid and sodium fluoride or hydrofluoric acid may also be used to anodize titanium. (See K. S. Raja, M. Misra and K. Paramguru, Electrochem. Acta, 51 (2005) 154-165.). This procedure, generally speaking, takes about 45 minutes to get anodized titanium using 20V under magnetic stirring. The anodizing approach is able to build a porous titanium oxide film of controllable pore size, good uniformity, and conformability over large areas at low cost. The anodization time may be reduced by 50% or more using ultrasonic mixing. This ultrasonic mixing process of the invention (discussed below) also leads to better ordered and uniform TiO₂ nanotubes compared to conventional stirring techniques. In addition, a barrier layer (i.e., the junction between the nanotubes and the titanium metal) forms during anodization. The barrier layer may be in the form of domes connected to each other (See, for example, FIG. 27).

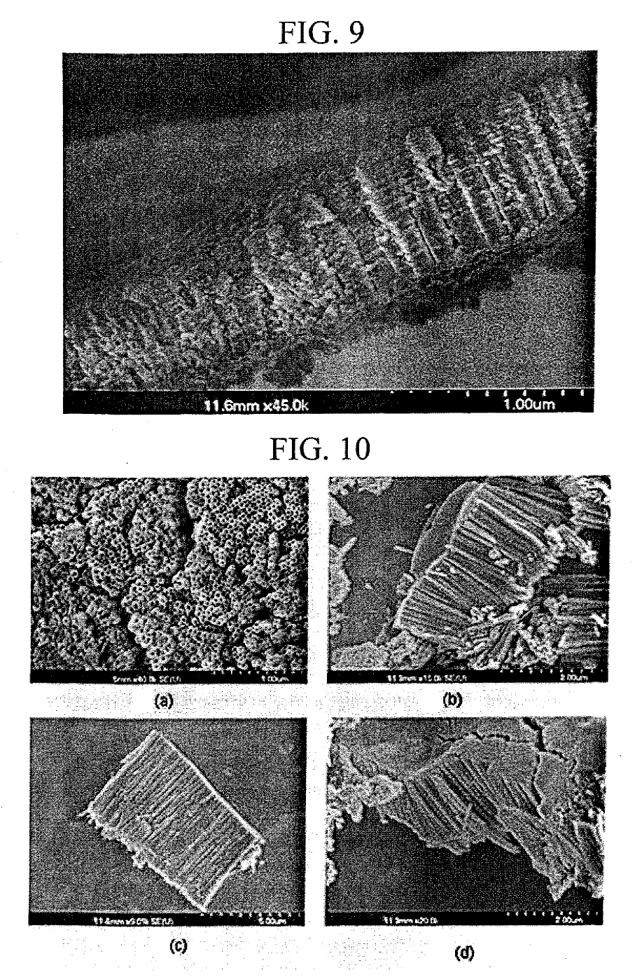

In general, titania nanotubes may be formed by exposing a surface of a titanium metal substrate to an acidified fluoride electrolyte solution at a voltage selected from a range from 100 mV to 40V, for a period of time ranging from about 1 minute to 24 hours, or more. Typically, the voltage used is about 20V and the anodization time is about 45 minutes to 8 hours. The acidified fluoride electrolyte is typically has a pH of less than about 6 and often a pH<4. Anodization under these conditions forms a titania surface comprised of a plurality of titanium dioxide nanotubes. Known anodization techniques may be used to anodize a titanium metal substrate to form a nano-tubular titania substrate having a surface comprised of self-ordered titanium dioxide nanotubes to be used in the practice of the invention. For example, a titanium metal substrate may be anodized using an aqueous or organic electrolyte, for example, 0.5 M H₃PO₄+0.14 M Na solution can be used for incorporating P atoms, 0.5-2.0 M Na(NO₃)+0.14 M NaF solution or a 0.5-2.0 M NH₄NO₃+0.14 M NH₄F with pH 3.8-6.0 for incorporating N atoms, or a combination of 0.5 M H₃PO₄+0.14 M NaF+0.05-1.0 M Na(NO₃). The anodization preferably occurs at a temperature of 20-25° C. The titanium metal substrate is then anodized at 20 V for 20 minutes after observing a plateau current. FIG. 2 depicts a typical anodization apparatus and anodization time. Preferred embodiments and novel adaptations of such anodization processes to prepare nano-tubular titania substrates are discussed below. For example, Example 1 describes an exemplary formation of a nanotubular titanium dioxide layer in which nanotubes ranging from 40-150 nm diameter are formed. Exemplary nano-tubes on a titanium surface after anodization by the method described in Example 1 are shown in FIGS. 8 and 9. In addition, Example 2 describes an example of the formation of anodized titanium templates in which a solution of 0.5 M H₃PO₄+0.14 M NaF was used for anodization.

Optional Cleaning of the Titanium Metal Substrate

Prior to anodization to form the titania nanotubes, the titanium metal substrate may be cleaned and polished using standard metallographic cleaning and polishing techniques known in the art. Preferably, the titanium metal substrate is chemically and/or mechanically cleaned and polished as known in the art Mechanical cleaning is preferably done by sonication. Titanium foils are not polished after cleaning. As an example, a titanium metal surface may be incrementally polished by utilizing 120 grit emery paper down to 1200 grit emery paper followed by wet polishing in a 15 micron alumina slurry. After polishing, the valve metal substrate is thoroughly washed with distilled water and sonicated for about 10 minutes in isopropyl alcohol as known in the art. Performing such optional cleaning and polishing aids in consistency of the titanium metal substrates used in the invention, that is, it ensures the titanium metal substrates have uniform starting points (e.g., planar surfaces when desired). While it is preferred to use polished surfaces, any native oxides on the titanium metal substrates do not necessarily need to be removed in order for the titanium metal substrate to be used in the invention.

The Acidified Fluoride Electrolyte

The acidified fluoride electrolyte used in the anodization step may be an aqueous electrolyte, an organic electrolyte solution, or a mixture thereof. Fluoride compounds which may be used in the electrolytes are those known in the art and include, but are not limited to, hydrogen fluoride, HF; lithium fluoride, LiF; sodium fluoride, NaF; potassium fluoride, KF, ammonium fluoride, NH₄F; and the like. It is preferred that the acidified fluoride electrolytes have a pH below 5, with a pH range of 4-5 being most preferred. Adjusting the pH may be done by adding acid as is known in the art. Inorganic acids such as sulfuric, phosphoric, or nitric acid, are generally preferred. Phosphoric acid and nitric acid are particularly preferred when phosphorous or nitrogen dopants are to be introduced as discussed below. Organic acids may be used to adjust pH and to introduce carbon as a dopant.

Any aqueous acidified fluoride electrolyte known in the art for the anodic formation of titanium dioxide nanotubes on titania substrates may be used in the practice of the invention. Suitable acidified fluoride electrolytes include, for example, a 0.5 M H₃PO₄+0.14 M NaF solution, a 0.5-2.0 M Na(O₃)+0.14 M NaF solution, a 0.5-2.0 M NH₄NO₃+0.14 M NH₄F, or a combination of 0.5 M H₃PO₄+0.14 M NaF+0.05-1.0 M NaNO₃). Preferred aqueous acidified fluoride electrolytes are discussed below.

Any organic solvent, or mixture of organic solvents, which is capable of solvating fluoride ions and is stable under the anodization conditions may be used as an organic electrolyte. As mentioned above, the organic electrolyte may also be a miscible mixture of water and an organic solvent. It is preferred that at least 0.16 wt % water be present in an organic electrolyte because water participates in the initiation and/or formation of the nanotubes. Preferably, the organic solvent is a polyhydric alcohol such as glycerol, ethylene glycol, EG, or diethylene glycol, DEG. One advantage of using an organic electrolyte is that during the annealing step, the organic solvent is volatized and decomposes under the annealing conditions but also results in carbon doping of the titanium dioxide nanotubes.

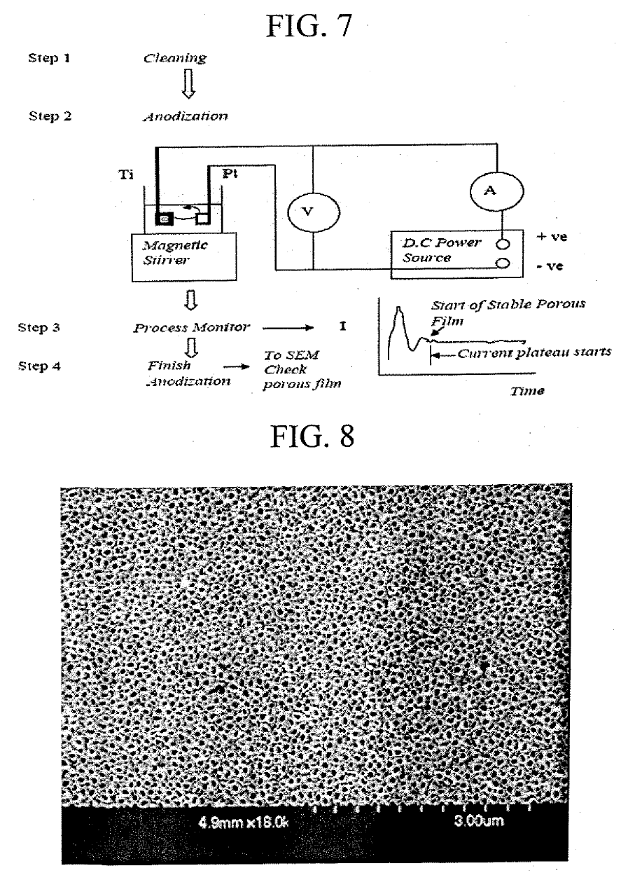

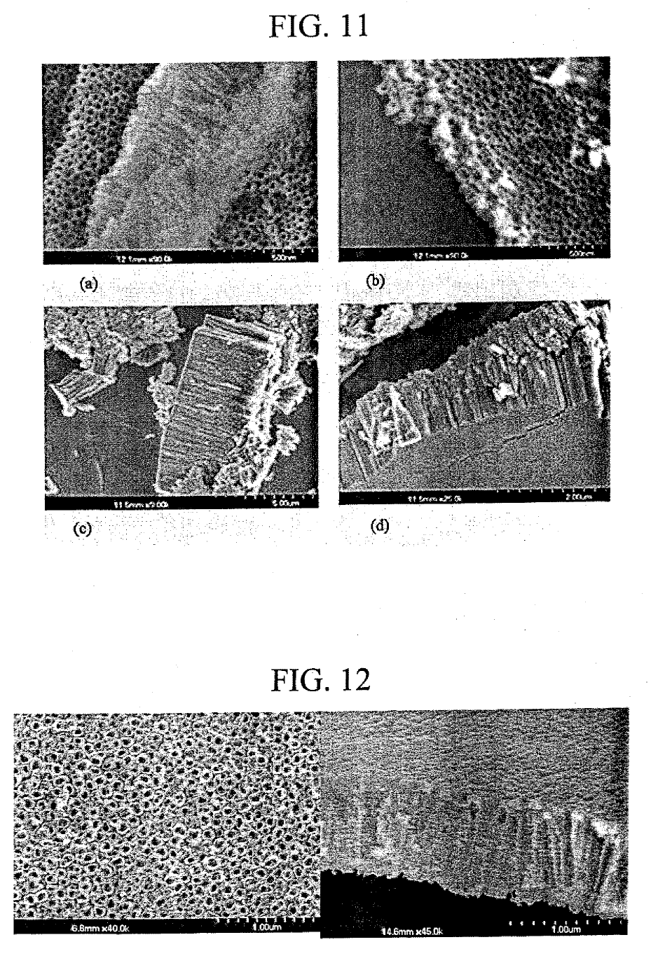

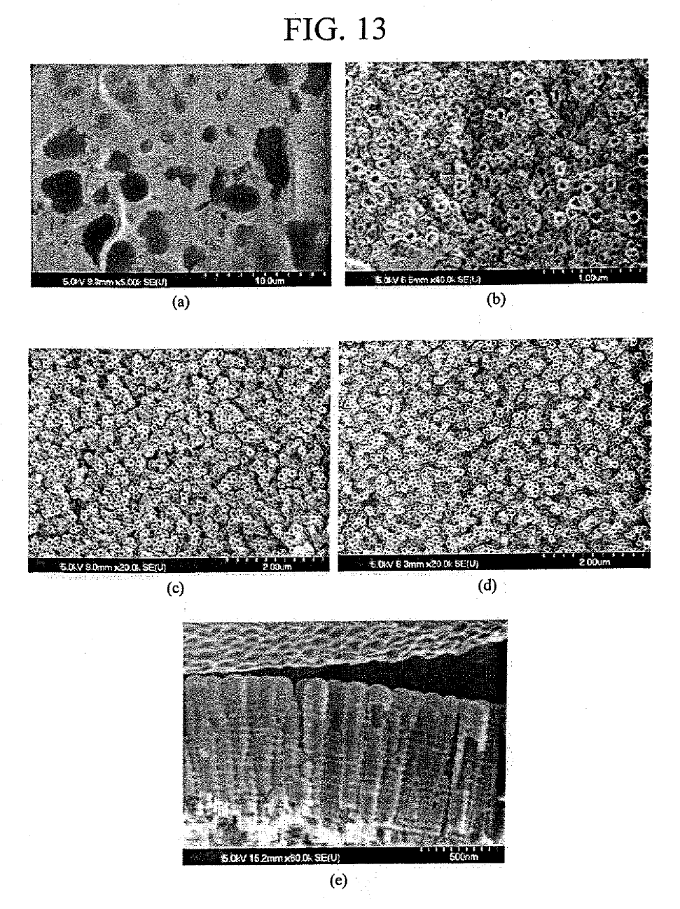

Example 3 describes a method for anodizing titanium in ethylene glycol/glycerol organic solvents. FIGS. 10-11 shows the results obtained in Example 3. In addition, Example 4 describes a method of anodizing titanium with a small amount of a common complexing agent, e.g. EDTA, and ammonium fluoride. The complexing agent, which is preferably added in the amount of 0.1 wt %, with 0.5-1.0 wt % being most preferred, allows for the formation of improved nanopores at a faster rate. Furthermore, Example 5 describes a method of anodizing titanium using a neutral solution of water and ethylene glycol. FIG. 13 shows SEM images of the nano-tubular TiO₂ obtained using the following neutral aqueous solutions: (a) EG+0.5 wt % NaF, (b) H₂O+0.5 wt % NaF, (c) [H₂O+EG (1:1 volume ratio)]+0.5 wt % NaF, (d) [H₂O+EG (1:3 volume ratio)]+0.5 wt % NaF, and (e) cross sectional view of (c). The above exemplary anodization procedures may be carried out using an anodization apparatus such as the ones illustrated in FIGS. 2 and 7.

Mixing During Anodization

The formation of the titanium dioxide nanotubes is improved by mixing or stirring the electrolyte during anodization.

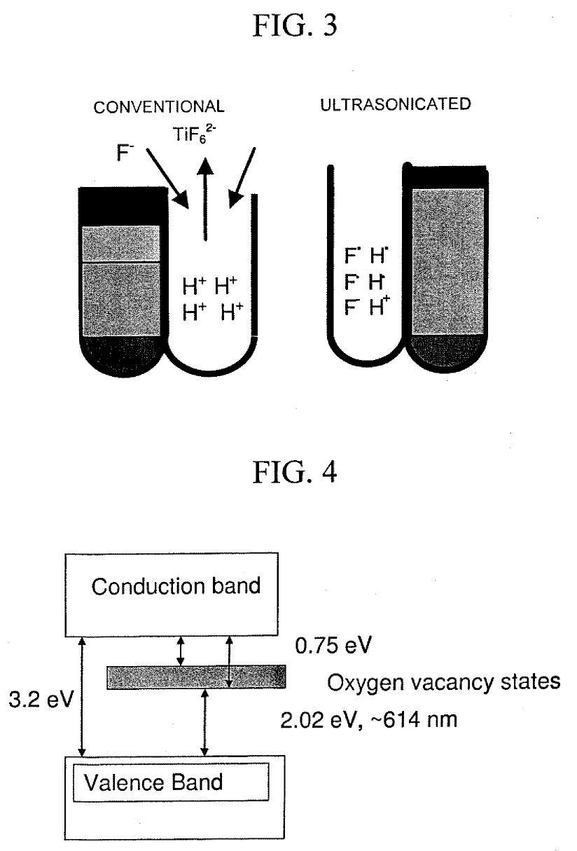

Conventional techniques for mixing or stirring the electrolyte may be used, e.g. mechanical stirring, magnetic stirring, etc. In a preferred embodiment, the mixing is achieved by ultra-sonicating the electrolyte solution during annodization. Sonication may be done using commercially available devices. Typical frequencies are about 40 kHz. As shown in FIG. 3, ultra sonicating the electrolyte during anodization aids in nanotube formation giving more uniform and smooth nanotubes than achieved with other mixing techniques. Conventional mixing results in H⁺ ions being produced by hydrolysis, a slow process. A pH gradient also exists along the nanotube. The availability of F⁻ ions to react and create the nanotubes is diffusion controlled. Ultra-sonication facilitates H and F radicals reaching the bottom surface of a forming nanotube, With ultra-sonication, the pH needed for pore formation also exists at the pore bottom. Ultra-sonication provides more uniform concentration of radicals and pH preventing or at least minimizing the existence of concentration and pH gradients which may occur during anodization.

Preparation of Titanium Dioxide Nanotubes Using Ultrasonic Waves

Anodization completed using an ultrasonicator is more efficient that conventional techniques. For example, the use of an ultrasonicator gives rise to better ordered TiO₂ nanotubes in a shorter time that mixing by conventional techniques. The synthesis time can typically be reduced up to 50% in this way. In addition, the pore openings and the length of the nanotubes can also be improved through ultrasonic mixing. For example, the length of the nanotubes can be increased to 700-750 nm.

Ultrasonic mediated anodization may be completed, for example, by washing Ti foil discs in acetone and securing the discs such that only small portions are exposed to an electrolyte. Nanotubular TiO₂ arrays are formed by anodizing the Ti foils in an acidified fluoride electrolyte. During the anodization of the TiO₂ arrays, an ultrasonicator was used to give mobility to the electrolytes, instead of a magnetic stirrer. After anodization, the anodized samples were washed in distilled water to remove the occluded ions from the anodized solutions and dried in oven and fabricated for photocatalysis of water. The various conditions used for anodization according to this method are listed in Examples 6 and 7 below. Various electrolytic combinations were used for this purpose both in aqueous and non-aqueous media.

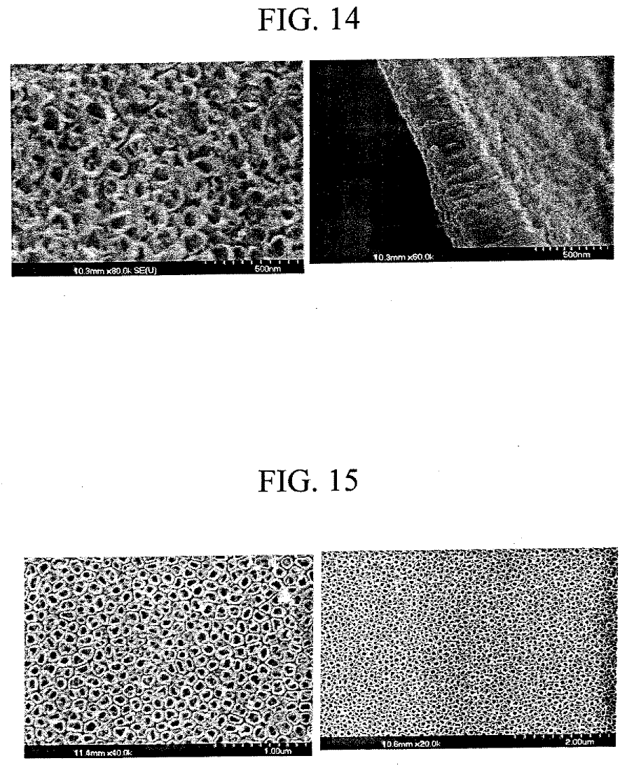

As indicated above, well ordered nanoporous TiO₂ tubes can be obtained much more quickly with ultrasonic mixing than conventional mixing techniques (i.e. 20 minutes) under an applied external potential of 20 V using, for example, phosphoric acid and sodium fluoride electrolytes. The effect of different synthesis parameters viz., synthesis medium (inorganic, organic and neutral), fluoride source, applied voltage and synthesis time are discussed below. The pore diameters can be tuned from 30-120 nm by changing the annodization process parameters such as anodization potential and temperature. The pore diameter increases with anodization potential and fluoride concentration, and the diameter decreases with the electrolyte temperature. A 300-1000 nm thick self-organized porous titanium dioxide layer can be prepared by this procedure in a very quick time. Anodization by ultrasonic mixing is significantly more efficient than the conventional magnetic stirring. The anodizing approach discussed above is able to build a porous titanium oxide film of controllable pore size, good uniformity, and conformability over large areas at low cost. Generally, the anodization step occurs over period of 1-4 hours. However, by using ultrasonic mixing techniques, the anodization time can be reduced by more than 50%. It also leads to better ordered and uniform titanium dioxide nanotubes compared to the reported ones using conventional magnetic stirring. Examples 6 and 7 describe methods of ultrasonic mediated anodization of titanium. The results of Example 6 are illustrated in FIGS. 14-21.

Formation of the TiO₂ Nanotubes

Generally speaking, the formation mechanism of the TiO₂ nanotubes can be explained as follows. In aqueous acidic media, titanium oxidizes to form TiO₂ (Equation 1).

Ti+2H₂O→TiO₂+4H⁺ (1)

The pit initiation on the oxide surface is a complex process. Though TiO₂ is stable thermodynamically in a pH range between 2 and 12, a complexing species (F⁻) leads to substantial dissolution. The pH of the electrolyte is a deciding factor. The mechanism of pit formation due to F⁻ ions is given by the equation 2;

TiO₂+6F⁻+4H⁺→[TiF₆]²⁻+2H₂O (2)

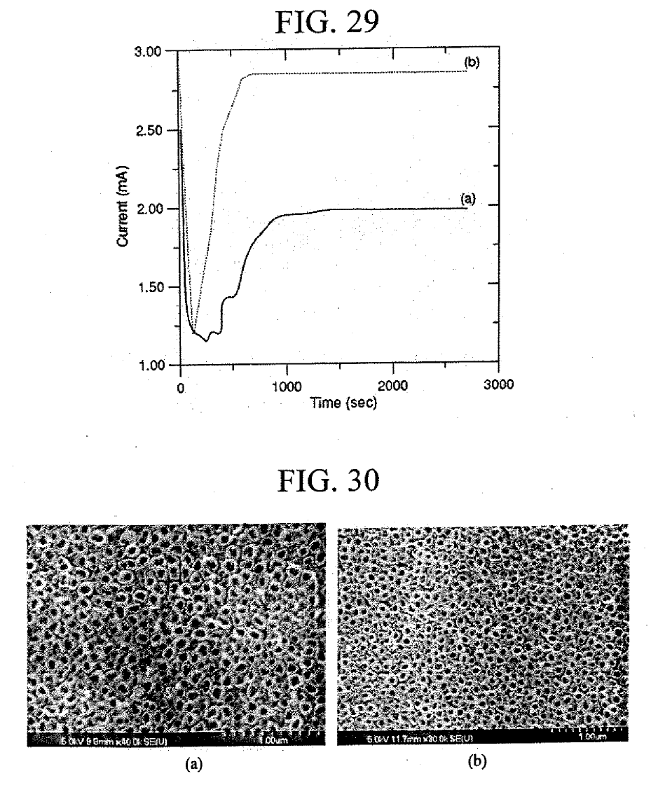

This complex forming leads to breakage in passive oxide layer and the pit formation continues until repassivation occurs. (See J. M. Macak, H. Tsuchiya and P. Schmuki, Angew. Chem., Int. Ed., 44 (2005) 2100-2102., K. S. Raja, M. Misra and K. Paramguri, Electrochem. Acta, 51 (2005) 154-165., and G. K. Mor, O. K. Varghese, M. Paulose, N. Mukherjee and C. A. Grimes, J. Mater. Res., 18 (2003) 2588-2593.). The formation of the nanotubes goes through the diffusion of F⁻ ions and simultaneous effusion of the [TiF₆]²⁻ ions. The faster rate of formation of TiO₂ nanotubes using ultrasonic waves according to the invention can be explained by the mobility of the F⁻ ions into the nanotubular reaction channel and effusion of the [TiF₆]²⁻ ions from the channel. The higher rate was further confirmed from current versus time plot (FIG. 29). It can be seen from the figure that the current observed in case of anodization using ultrasonic is almost double compared to the anodization process using magnetic stirring. It is also notified that the current saturates in 500-600 sec in case of ultrasonic compared to 1000-1200 sec using magnetic stirring. The saturation of current with time indicates the repassivation occurs, which means the saturation of formation of nanotubes. This result is in line with our SEM studies. Anodization of titanium using other fluoride sources like ammonium fluoride and potassium fluoride were also carried out using ultrasonic waves. The SEM images (FIG. 30) shows that any fluoride source can be used for this purpose.

Influence of Anodization Time

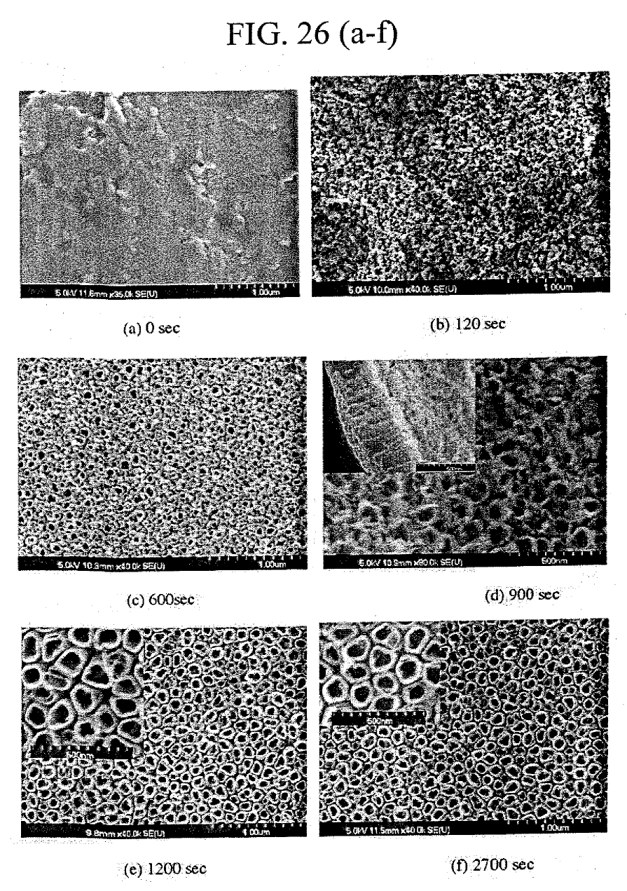

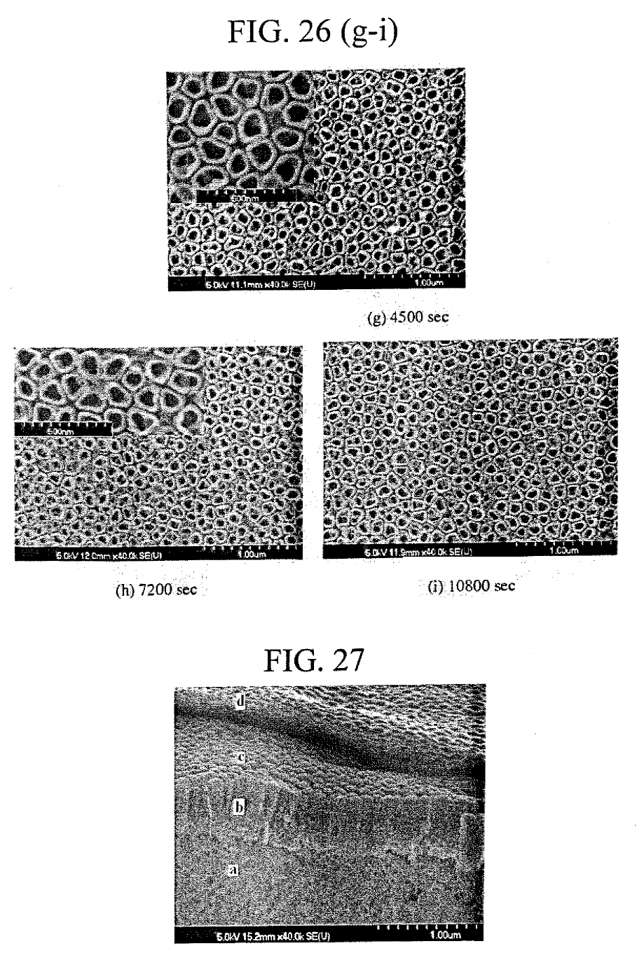

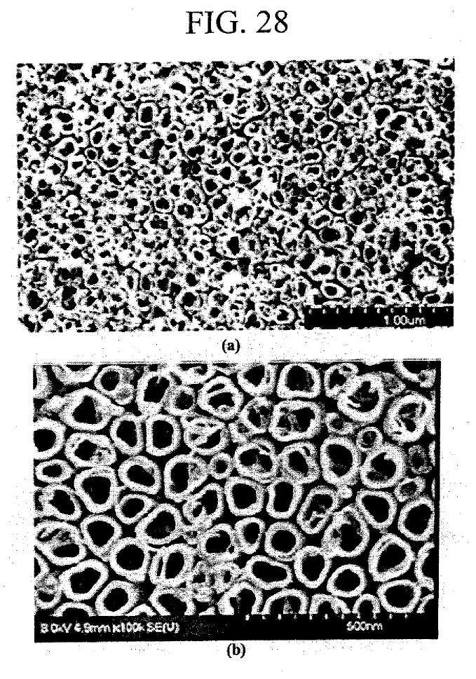

The growth of nanotubes can be improved as anodization time increases. For example, as shown in FIGS. 26-28, after 120 sec of anodization, small pits start to form on the surface of titanium (FIG. 26). These pits increase in size after 600 secs, though still retaining the inter-pore areas. After 900 seconds, most of the surface has covered with titanium dioxide layer, however the pores are not well distinct. After 1200 seconds, the surface is completely filled with well-ordered nanopores. To further find out the effect of time on these nanopores, the anodization time was further increased to 2700 seconds and 4500 seconds. It is observed that further increase in time to 7200 seconds and 10800 seconds, does not affect the pore diameters and as well as the length of the nanotubes. For comparison, when a duplicate sample was anodized under magnetic stirring, a disordered pore surface was obtained after 1500 seconds and ordered nanotubes were formed only after 2700 seconds. (FIG. 28). The length of the nanotubes is also found to be around 500 nm. The anodizing solution used in this case consisted of 0.5 M H₃PO₄ and 0.14 M NaF, and the anodization occurred at room temperature (22-25° C.), with an anodization voltage of 20V. The growth of nanoporous TiO₂ tubes was monitored by FESEM (FIG. 26).

Influence of Applied Potential

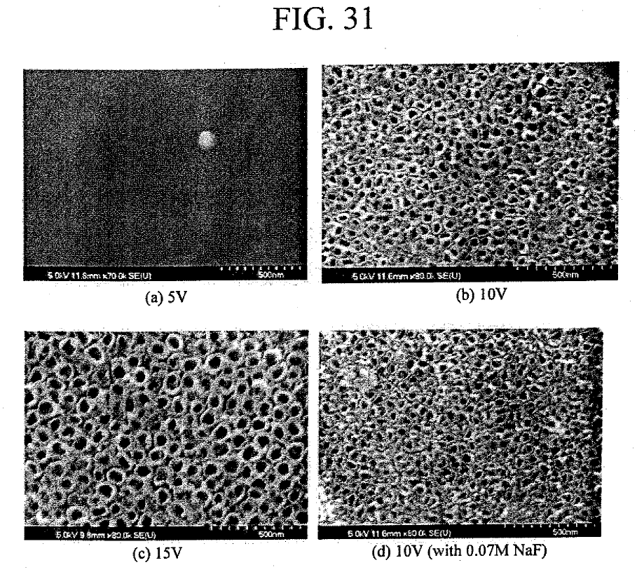

The applied potential may also affect nanotubes formation and pore size. As is described below in Example 10, the applied potential was varied from 5V to 20V by keeping the electrolytic solution and time constant, while mixing with ultrasonic waves. FIG. 31 indicates that an applied potential of 5V is not enough for the preparation of nanotubular TiO₂, while 10V is sufficient to prepare the nanotubular TiO₂. However, pore uniformity and order increase upon an application of increased applied potentials, such as 15V to 20V, to the system, Pore size also increases with the application of the higher applied potentials. Thus, the pore openings of the TiO₂ nanotubes can be tuned as per the requirements by changing the synthesis parameters, including applied voltage and/or fluoride ion concentrations.

Double Sided Anodization of Titanium

Another embodiment of the invention relates to a method of anodizing titanium on more than one side. This process, which is described in Example 11, consists of suspending titanium foil in an electrolytic solution under an applied voltage for a predetermined period of time. The resulting double-sided anodization exhibited a good photo activity of 0.4 mA from each side, whereas conventional single sided anodization has a photo activity of approximately 0.1 mA, without any treatment of the nanoporous titanium.

Non-Oxidative Annealing and Band-Gap Engineering

After the anodization step, the band gap of the nanotubular titanium dioxide layer may be reduced by annealing in a non-oxidating (a neutral or a reducing) atmosphere (e.g., nitrogen, hydrogen, cracked ammonia, etc.) and, depending upon the atmosphere, doping any combination of elements, such as, Group 14, 15, 16, and 17 elements, for example, carbon, nitrogen, hydrogen, phosphorous, sulfur, fluorine, selenium, and the like. The reduced band gap results in absorption of larger spectrum of light, particularly solar light in the visible wavelength region, and therefore generates increased photocurrent and efficiency, thereby leading to higher rate of hydrogen generation.

This “non-oxidative annealing,” that is annealing of the titanium dioxide nanotubes in a vacuum, a neutral atmosphere, or a reducing atmosphere. The annealing preferably occurs at a temperature of approximately 350° C. over a period of about 6 hours in any suitable annealing apparatus. Annealing in a non-oxidative, preferably a reducing atmosphere, allows the band gap to be engineered and retains and/or creates more oxygen vacancies in titania nanotubes. Neutral or reducing atmospheres include environments containing carbon, nitrogen, hydrogen, sulfur, etc. Annealing in a reducing atmosphere creates oxygen vacancies which lower the band gap of the titanium dioxide nanotubes. (See FIG. 4). The annealing may also be carried out in a neutral (N₂) environment, or in an environment having a low O₂ partial pressure. In contrast, annealing in an oxidative (oxygen rich) atmosphere converts any oxygen vacancies to TiO₂ sites. The nano-tubular substrate may be washed and dried prior to the annealing to remove the electrolyte solution from the surface and nanotubes.

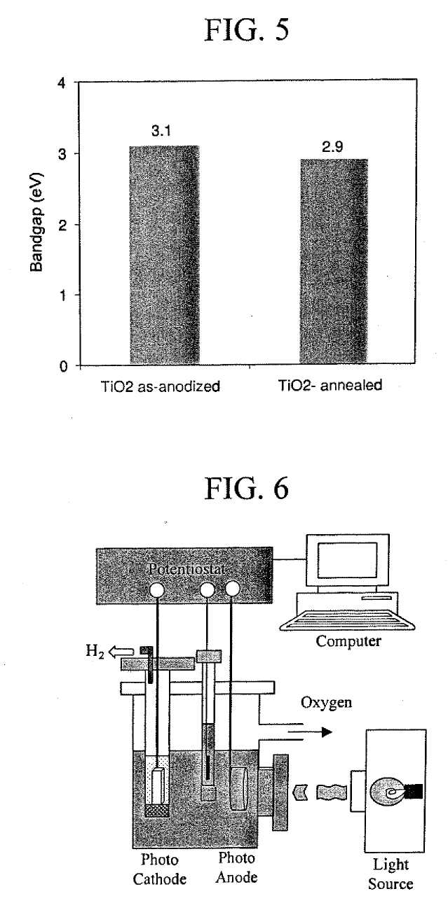

As mentioned above, the non-oxidative annealing gives the a band gap in the range of about 1.9 to about 3.0 eV. The reduced band gap of the nano-tubular titania substrates of the invention makes them useful in generating hydrogen by photo-electrolysis of water by solar light. The preferential band gap for effective photoelectrolysis of water is 1.6-2.1 eV. FIG. 5 shows the differences in band gap before and after annealing according to the invention.

Doping the Titania Layer

As indicated above, the nanotubular titania substrate may be doped in any combination of elements, such as, Group 14, 15, 16, and 17 elements, for example, carbon, nitrogen, hydrogen, phosphorous, sulfur, fluorine, selenium, and the like. The doping may be conducted by conventional means known in the art, for example, by conventional diffusion techniques such as solid source diffusion, gas diffusion, and the like. In one embodiment, doping is preferably conducted via a thermal treatment, such as the annealing step, in carbon or nitrogen or sulfur containing environments. While either nitrogen-doping or carbon-doping may occur separately, it is preferred that both occur.

For example, in order to incorporate carbon, the anodized sample may be heated at 650-850° C. in a mixture of acetylene or methane/hydrogen/argon gases with a flow rate of 20 cc/minute, 40 cc/minute, and 200 cc/minute respectively using a Chemical Vapor Deposition Furnace. The total exposure time in carbon containing gas atmosphere varies from 5-30 minutes. This heat treatment of the anodized specimens in the carbon containing gas mixture resulted in incorporation of carbon in the nanotubes of TiO₂ arrays, which will be hereinafter referred as carbon modified TiO₂ nanotubes.

The size of the carbon modified TiO₂ nanotubes were in the range of approximately 200-500 nm. Increasing the exposure time in the carbonaceous environment resulted in growth of carbon nanostructures within the TiO₂ nanotubes. The amount of carbon incorporation increased with increase in treatment time and the color of the samples also changed from light gray to dark-gray. Treatments in acetylene for longer than 20 minutes resulted in a complete coverage of the TiO₂ with the carbon nano-cone like features.

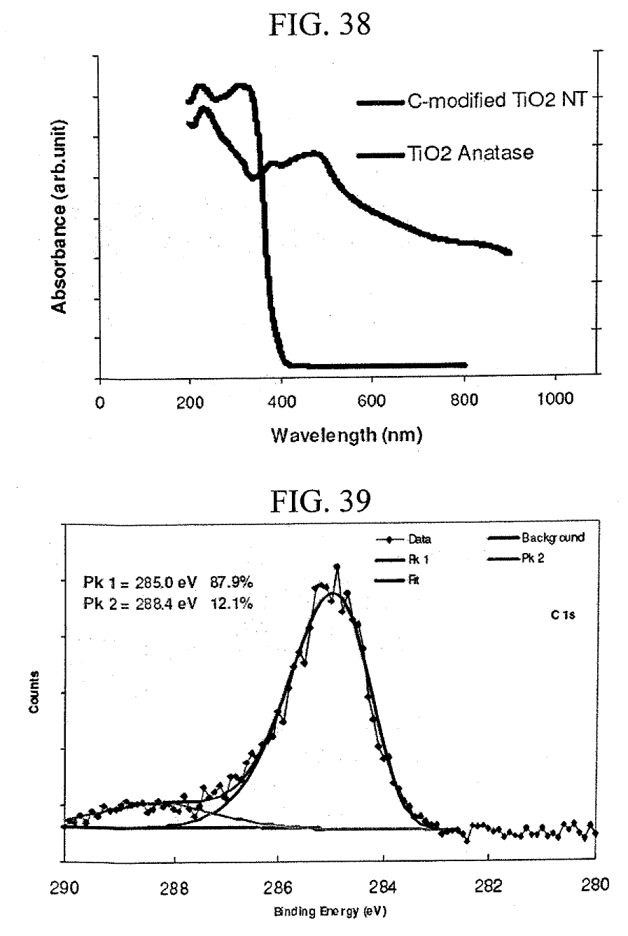

FIG. 38 shows a comparative absorption spectra of samples modified by deposition of nano-structured carbon (carbon modified TiO₂ nanotubes) annealed in a acetylene+hydrogen gas mixture at 650° C. for 10 minutes and standard anatase powder absorbance. The presence of carbon resulted in light absorption in the visible range of wavelengths in addition to the regular absorption of titanium oxide. TiO₂ was present as ordered nanotubes as against nano-particles or thin oxide layer reported in the literature and the carbon was present as carbon nano-structure forming a composite material. The adsorption at visible wavelengths increased with increase in carbonaceous treatment time. The width of the additional shoulder to the major TiO₂ absorbance peak decreased with increase in heat-treatment time of the samples in carbon-containing gas atmosphere. FIG. 39 shows a typical C 1 s XPS spectrum of the carbon modified TiO₂ nanotubular sample. The peak at 288.4 eV could be attributed to the carbonate type species incorporated in the nanotubes during thermal treatment in acetylene gas mixture.

As another example, nitrogen doping may be conducted prior to the formation of the carbon modified TiO₂ nanotubes. More specifically, doping of nitrogen is accomplished by heat-treating anodized (preferably in nitrate containing solutions) Ti samples at 350° C. for 3-8 hours in a nitrogen containing atmosphere. Commercial purity nitrogen/cracked ammonia may be passed over the anodized Ti surface at a flow rate of 150-1000 cc/minute inside a furnace maintained at 350° C. Similarly, doping of sulfur or selenium may be accomplished by heat-treating anodized samples embedded in sulfur or selenium powders at 300-650° C. for 1-6 hours. Optionally, the doping may be conducted on the nanotubular structure after the formation of the carbon modified TiO₂ nanotubes.

In one embodiment, carbon modified TiO₂ nanotubes may be formed after nitrogen doping. In this case, the doping of nitrogen can be accomplished by heat-treating the anodized (preferably in nitrate containing solutions) Ti samples at 350° C. for 3-8 hours in nitrogen atmosphere. Commercial purity nitrogen/cracked ammonia is passed at a flow rate of 150-1000 cc/minute inside a furnace maintained at 350° C. Similarly, doping of sulfur or selenium may be accomplished by heat-treating the anodized samples embedded in sulfur or selenium powders at 300-650° C. for 1-6 hours. In another embodiment, the nitrogen doping may be conducted on the nanotubular structure after the formation of the carbon modified TiO₂ nanotubes.

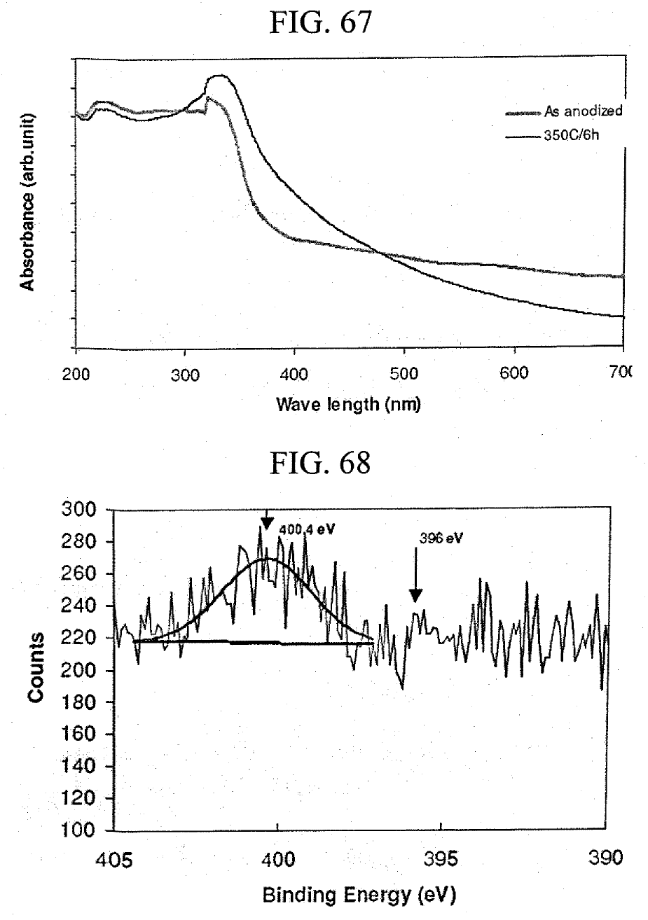

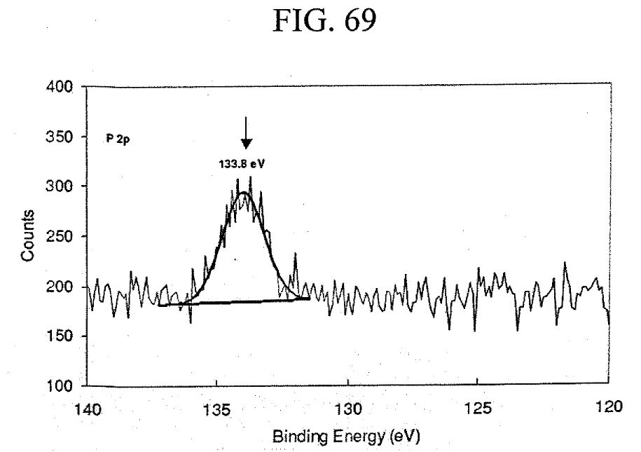

Example 21 describes phosphorous doping and the benefits thereof. In particular, the nanotubular TiO₂ arrays of the invention may be anodized in a various phosphate solutions, such as 0.5 M H₃PO₄+0.14 M NaF. Table 1 illustrates the various band-gaps that can be achieved in this manner. As is shown in FIGS. 67-68, samples anodized in phosphate solutions generally showed better optical absorption than samples anodized in nitrate solutions. Thus, it appears that the anodization in phosphate solutions, such as 0.5 M H₃PO₄+0.14 M NaF, results in adsorption of phosphate ions at the outer walls of the TiO₂ nanotubes, and that and subsequent annealing causes diffusion of the phosphorous species in the TiO₂ lattice, thereby creating sub-band gap or surface states. FIG. 69 shows the high resolution P 2 p XPS spectrum and the peak at 133.8 eV indicates incorporation of phosphorous species in the TiO₂ nanotubes.

Table 1 below illustrates various band-gaps achieved by annealing and doping the TiO₂ with different elements.

TABLE 1
Electronic band-gap of aqueous anodized nanotubular
TiO₂ doped with different elements.

| | | Band-Gap |
|---|---|---|
| SAMPLE | | (eV) |
| 1. | Anodized in H₃PO₄ + NaF | 2.9 |
| | Above Annealed in N₂ 350° C., 6 h | 2.8 |
| 2. | Anodized in 0.5M NaNO₃ + NaF and Nitric Acid, | 3.2 |
| | pH 4, 1 h | |
| | Above annealed in N₂, 350° C., 6 h | 3.1 |
| 3. | Anodized in 0.5M NaNO₃ + NaF and Nitric Acid, | 3.1 |
| | pH 4, 2 h | |
| | Above annealed in N₂, 350° C., 6 h | 3.0 |
| 4. | Anodized in 0.5M NaNO₃ + NaF and Nitric Acid, | 3.1 |
| | pH 4, 4 h | |
| | Above annealed in N₂, 350° C., 6 h | 3.0 |
| 5. | Anodized in 0.5M NaNO₃ + NaF and Nitric Acid, | 3.2 |
| | pH 5, 1 h | |
| | Above annealed in N₂, 350° C., 6 h | 3.0 |
| 6. | Anodized in 0.5M NaNO₃ + NaF and Nitric Acid, | 3.2 |
| | pH 5, 2 h | |
| | Above annealed in N₂, 350° C., 6 h | 3.1 |
| 7. | Anodized in 0.5M NaNO₃ + NaF and Nitric Acid, | 3.0 |
| | pH 5, 4 h | |
| | Above annealed in N₂, 350° C., 6 h | 3.0 |
| 8. | Anodized in H₃PO₄ + NaF, Carbon doped at | 3.3 |
| | 650° C., 5 minutes | |
| 9. | Anodized in H₃PO₄ + NaF, Carbon doped at | 2.5 |
| | 650° C., 5 minutes (secondary absorption) | |
| 10. | Anodized in H₃PO₄ + NaF, Carbon doped at | 2.7 |
| | 650° C., 10 minutes | |
| 11. | Anodized in H₃PO₄ + NaF, Carbon doped at | 2.8 |
| | 650° C., 15 minutes | |
| 12. | Anodized in H₃PO₄ + NaF, Carbon doped at | 2.8 |
| | 650° C., 20 minutes | |

Photogeneration of Hydrogen

Photoelectrochemical cells known in the art may be used with a nano-tubular titanium anode of the invention to generate hydrogen. Generally, photoelectrochemical cells irradiates an anode and a cathode to generate H₂ and O₂. An schematic of an exemplary photoelectrochemical cell for generating hydrogen is illustrated in FIG. 6. As can be seen in FIG. 6, there are separate compartments for the anode, the cathode, and optionally, a reference electrode. In larger systems, a reference electrode may not be used. The compartments are connected using porous glass or ceramic frits or salt bridge for ionic conductivity/transport. An advantage of this technique is that there is no need to separate H₂ and O₂. Moreover, it is thought that utilizing both the photoanode and photocathode gives a dual fold increase in efficiency. Although FIG. 6 shows side-on irradiation of the anode and cathode, irradiation may be from any or all directions. FIG. 6 also depicts preferred Quartz lenses for irradiation.

While any suitable electrolyte solution known in the art may be used in the photoelectrochemical cell, preferred electrolyte solutions include aqueous basic, acidic or salt solutions with good ionic conductivity, for example, 1 M NaOH, 1 M KOH (pH˜14), 0.5 M H2SO4 (pH˜0.3) and 3.5 wt % NaCl pH˜7.2) aqueous solutions. The same electrolyte can be filled in both anode and cathode compartments. Alternately, anodic compartment can have higher pH solution such as KOH and cathodic compartment have acidic solution such as sulfuric acid. Specifically, with reference to FIG. 6, an exemplary photoelectrochemical cell for generating hydrogen in accordance with the invention is described in Example 14.

The Photo-Anode

While any suitable photo-anode may be used in typical photoelectrochemical cells known in the art, the photoelectrochemical cells of the invention preferably utilize nanotubular titania substrates of the invention, as discussed above, as the photo-anode.

The Photo-Cathode

Generally speaking, any photocathode known in the art may be used to generate hydrogen according to the invention. However, two preferred types of photocathodes include (1) cadmium telluride (CdTe) or cadmium zinc telluride (CdZnTe, or CZT) coated platinum foils, and (2) anodized TiO₂ nanotubes coated with nanowires of CdTe or CdZnTe. The deposition is accomplished by depositing the elements at substantially the same time in an organic solvent and in an inert dry atmosphere (e.g., in an inert glove box). The solvent should have sufficient dielectric constant for the electrolysis. Exemplary solvents include, but are not limited to, propylene carbonate, acetonitrile, dimethyl sulfoxide (DMSO), tetrahydrofuran (ThF), and dimethyl formamide (DMF).

Typical electrolyte compositions include, for example, 10×10⁻³ M ZnCl₂+5×10⁻³ M CdCl₂+0.5 and 1.0×10⁻³ M TeCl₄+25×10⁻³ M NaClO₄ in propylene carbonate. 30×10⁻³ M NaClO₄ may be used as a supporting electrolyte. It is preferred that the depositions be carried out in a controlled atmosphere inside a glove box, with ultra high purity argon being used as an inert atmosphere. The oxygen and moisture contents of the glove box were controlled at low levels. Nanowires of CdZnTe were deposited on the nanoporous TiO₂ template by pulsing the potentials, and a typical pulsed-potentials cycle contained two cathodic, two anodic and one open circuit potential. All potentials were applied with respect to the cadmium reference electrode. Cathodic pulsed potential can be varied between −0.4V to −1.2 V, for example, and pulsed for 1 second. The anodic pulsed potentials were kept constant in all the test runs. The two anodic potentials used were 0.3V for 3 secs and 0.7V for 5 secs. The deposition time was typically around 30 minutes.

Both the photoanode and photocathode may be coated with the above-described electrodeposition technique. Optionally, a subsequent treatment may be used to stabilize the coating as known in the art. For example, a thermal treatment may be applied to the coating. Example 17 describes an exemplary method of coating CdTe or CdZnTe nanowires/thin films, and Example 18 describes a method of forming CdZnTe nanowires in a single step electrochemical synthesis using the nanoporous TiO₂ template of the invention in a non-aqueous solution.

Photoelectrochemical Cells

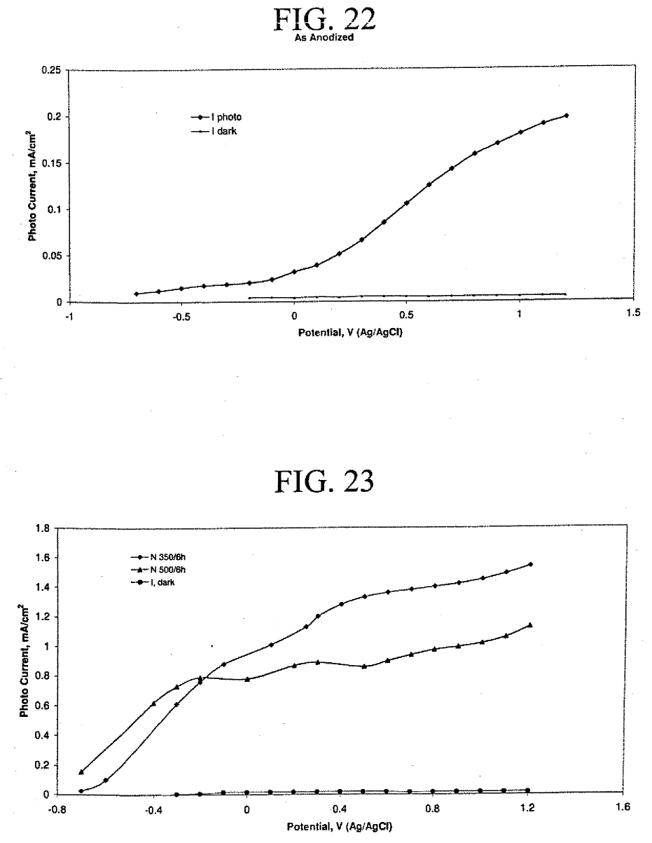

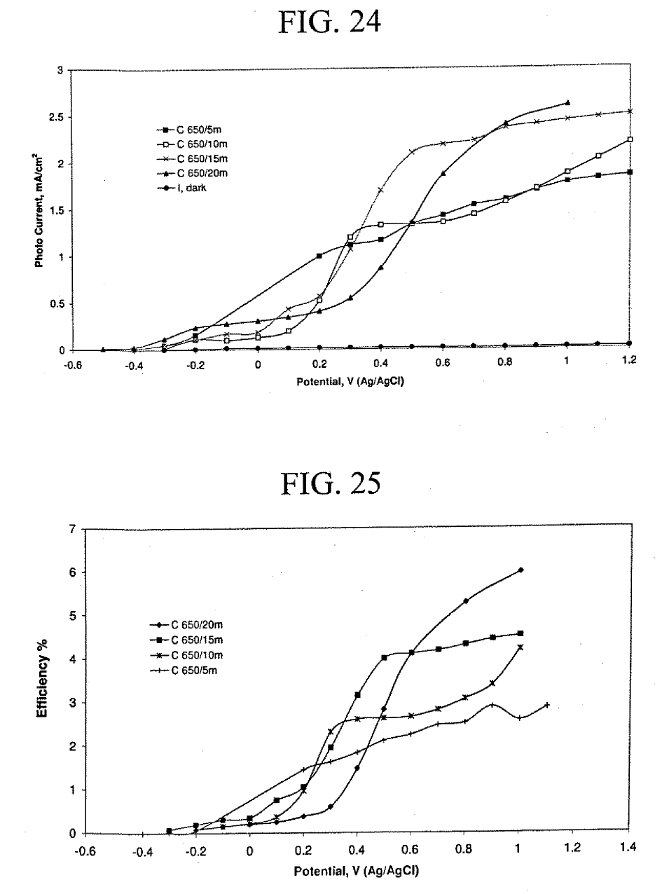

By irradiating both an anode and cathode in an photoelectrochemical cell or by using acidic solution in the cathode compartment and a basic solution in anodic compartment, the external supply of electrical energy can be eliminated or minimized for higher rate of hydrogen generation. For example, Example 8 describes the use of photo-anodes in the invention. FIGS. 22-24 illustrate the results of photocurrent generated during solar light irradiation of the photo-anodes described in Example 8. FIG. 22 illustrates the photocurrent generated at different potentials of the as-anodized TiO₂ electrode (conduction 1). FIG. 23 illustrates the photocurrent of nitrogen doped nano-tubluar TiO₂ electrode. As is shown in FIG. 23, N350/6 h was the specimen annealed in nitrogen at 350° C. for 6 h in nitrogen and N500/6 h was annealed in nitrogen at 500° C. for 6 h. Dark current during application of potential (without irradiation) is included for comparison. FIG. 24 illustrates the photocurrents of carbon doped TiO₂.

FIG. 25 illustrates the photoconversion efficiency of carbon doped nanotubular photoanodes as a function applied electrical potential, and shows the photoconversion efficiency, η, of the photo-anodes at different applied potentials. The efficiency was calculated from the following relation

$$η = \frac{{I}_{ph} * Δ E}{{I}_{o}} \times 100$$

where,
Iₚₕ=measured photocurrent at measured external potential, cm²
ΔE=E_{cell-light}−E_{cell-dark}, V (photo potential developed between anode and cathode due to light illumination in comparison with the dark condition under external bias)
E_{cell-light}=measured potential difference between anode and cathode under light illumination (under applied bias Vs a standard reference electrode)
E_{cell-dark}=potential difference between anode and cathode without light illumination
I_{O}=Light intensity irradiated on the photo anode, mW/cm²

The efficiency of the system increased with increased external potential, because both the photocurrent and the potential between photo-anode and cathode also increased. The hydrogen evolution at the cathode and oxygen evolution at the anode could be visibly observed when anode was irradiated with light in addition to applied potential. When the light was cut-off maintaining the external potential, the evolution of gases stopped immediately and the measured current dropped to less than 20 microampere level from few milliamperes.

FIGS. 14-21 show FESEM images of titanium oxide nanopores formed under various conditions using ultrasonic-mediated anodization. The ultrasonic process of the invention gives many advantages, including, for example, well ordered titanium dioxide nanopores, a reduction of anodization time, and long, well stabilized nanotube films.

### EXAMPLES

### Example 1

### Formation of Nanotubular Titanium Dioxide Layer

An exemplary nanotubular structure was formed as follows:

Step 1: A Ti metal surface was cleaned using soap and distilled water and further cleaned with isopropyl alcohol.

Step 2: The Ti material was immersed in an anodizing solution, as described below, at room temperature. Various combinations of solutions can be employed in order to incorporate doping elements such as nitrogen, phosphorous etc. For example 0.5 M H₃PO₄+0.14 M NaF solution can be used for incorporating P atoms, and 0.5-2.0 M Na(NO₃)+0.14 M NaF solution or a 0.5-2.0 M NH₄NO₃+0.14 M NH₄F with pH 3.8-6.0 can be used for incorporating N atoms. Combinations of 0.5 M H₃PO₄+0.14 M NaF+0.05-1.0 M Na(NO₃) can also be used.

Step 3: A direct current (DC) power source, which can supply 40 V of potential and support 20 mA/cm² current density, was connected to the Ti material and a platinum foil (Pt rod/mesh) having an equal or larger area of the Ti surface. The anodization set-up is schematically shown in FIG. 7. The Ti material to be anodized was connected to the positive terminal of the power source, and the platinum foil was connected to the negative terminal of power source. An external volt meter and an ammeter were also connected to the circuit in parallel and series respectively for measuring the actual potential and current during anodization. The distant between Ti and Pt was maintained at about 4 cm.

Step 4: The anodization voltage was applied in steps (0.5 V/minute) or was continuously ramped at a rate of 0.1 V/s from open circuit potential to higher values, typically 10-30 V. Generally, the voltage was ramped at a rate of 0.1 V/s and the typical final anodization potential was 20 V. This process resulted in a pre-conditioning of the surface to form nanoporous surface layer.

Step 5: After reaching the final desired anodization potential, the voltage was maintained, and the surface was anodized, at a constant value of 10-30 V, with 20V being preferred, to form the nano-pores/tubes (40-150 nm diameter). The current was continuously monitored and the anodization was stopped approximately 20 minutes after the current has reached a plateau value. The anodization process took about 45 minutes for solutions with pH<3 to get 400 nm long nanotubes. In pH 2.0 solutions, the steady state length of the TiO₂ nanotubes was about 400 μm. Longer anodization times (>45 minutes) did not result in longer nanotubes (longer than the steady state length). Longer anodization times were allowed for higher pH solutions, which resulted in longer nanotubes. For example, in 0.5 M NaNO₃+0.14 M NaF solution with pH 4.0, anodization for 4 hours resulted in 800 nm long nanotubes.

Step 6: The electrolyte was continuously stirred during the anodization process.

Step 7: The nano-pores obtained on the titanium surface after anodization are shown in FIGS. 8 and 9. As can be seen from FIG. 8, the porous size is approximately 60-100 nanometers.

### Example 2

### Production of anodized Titanium Templates

Titanium discs of diameter 16 mm and thickness 0.2 mm (0.2 mm thick, ESPI-metals, Ashland, Oreg., USA) were cleaned by sonication in acetone, isopropanol and methanol respectively and then rinsed in deionized water. The dried specimens were placed in a Teflon holder (from Applied Princeton Research, Oak Ridge, Tenn.) exposing only 0.7 cm² of area to the electrolyte for anodization. The solution of 0.5 M H₃PO₄+0.14 M NaF was used for anodization, conducted at room temperature under a voltage of 20 V for 45 minutes with constant mechanical stirring. The morphologies of the resulting nano-porous titanium oxide were studied using a Hitachi S-4700 field emission scanning electron microscope (FESEM) and Shimadzu UV-VIS photospectrometer.

### Example 3

### Anodization of Titanium in Ethylene Glycol/Glycerol Organic Solvents

First, anodized titanium templates were prepared. Titanium discs having 16 mm diameters and a thickness of 0.2 mm (0.2 mm thick, ESPI-metals, Ashland, Oreg., USA) were cleaned by sonicating in acetone, isopropanol, and methanol respectively, and then rinsed in deionized water. The dried specimens were then placed in a Teflon holder (from Applied Princeton Research, Oak Ridge, Tenn.) exposing only 1 cm² of area to the electrolyte for anodization.

Anodization was done in two types of organic solvents. The first was glycerol based and other was ethylene glycol based. The following combination of electrolytes were used:

(a) 0.5 wt. % NH₄F & 8.75 wt. % Ethylene Glycol in Glycerol.

(b) 0.5 wt. % NH₄F & 27.5 wt. % Ethylene Glycol in Glycerol.

(c) 0.4 wt. % NH₄F in Ethylene Glycol.

The anodization was done by ramping the potential to 20V at a rate of 1V/s after which the potential was kept constant at 20V. The anodization was carried out for 45 minutes, 7 hrs., and 14 hrs. respectively in the case of the glycerol based electrolyte, and for 45 minutes and 7 hrs. in the case of the ethylene glycol based electrolyte. Each of the above samples were anodized at room temperature, and the morphologies of the resulting nano-porous titanium oxide were studied using a Hitachi S-4700 field emission scanning electron microscope (FESEM).

For the anodization in the glycerol based electrolyte, the FESEM image showed uniform coverage of titanium oxide nanopores on the surface. The tubes appeared to be arranged in the form of bundles (FIG. 10(a)) and seemed to be significantly different from the tubes produced in water based electrolytes [0.5 M phosphoric acid (H₃PO₄) and 0.15 M Sodium Fluoride (NaF)]. The tubes were approximately 40 nm in diameter and 5 μm (FIG. 10(c)) in length for the 14 hr. anodized sample. The 7 hr. anodized sample gave a length of more than 3 μm (FIG. 10(b)) and the 45 minute samples were 600 nm long. The tubes appeared to be very smooth, long and without any ripples (FIGS. 10(b), 10(d)) which are generally observed when water based electrolytes are used.

For the anodization in the ethylene glycol based electrolyte, the surface looked more uniform and the tubes seemed to be spaced more uniformly over the surface. Also the bundles kind of arrangement mentioned in case of glycerol based electrolyte was not seen. As with glycerol based electrolytes, very long tubes ˜5 μm in length were obtained at a relatively short anodization time of 7 hrs. See FIG. 11. The tubes were very similar to the ones obtained for the glycerol based electrolyte mentioned above except that some faint rough edges could be observed in this case (FIG. 11(c)). So the tubes seemed to be slightly less smooth compared to the glycerol based samples. The tubes were approximately 40 nm in diameter and 5 μm in length for the 7 hr. anodized sample & 600 nm long for the 45 minute sample. (See FIGS. 11(c) and 11(d)).

### Example 4

### Anodization Using Organic Acid (EDTA+NH₄F)

The titanium metal substrate was also anodized using an organic acid, ethylenediamine tetraecetic acid (EDTA), and ammonium fluoride. The electrolyte was prepared by mixing 0.5 wt % of ammonium fluoride in a saturated solution of EDTA and water. As is discussed above, a small amount of a common complexing agent, such as EDTA, may be added to allow for the formation of improved nanopores at a faster rate. The solubility of EDTA in water is 0.5 g/Lt at room temperature. The pH of the solution was monitored to be 4.1. FIG. 12 shows that even if the pH of the solution is quite high, a complete anodization with ordered nanopores are able to form in just 1800 sec. This is the first ever report on anodization where a mixture of complexing agent and water used as the electrolytic solvent. The pore openings are found to be 60-80 nm and the tubular length was found to be 900 nm. This leads to a novel procedure to prepare longer tubes at high pH in very short time.

### Example 5

### Anodization Using Neutral Solution (Water and Ethylene Glycol:EG)

The titanium metal substrate may also be anodized in a neutral solution (water and ethylene glycol) instead of the inorganic acid (H₃PO₄) in 0.5 wt % sodium fluoride. Anodization in water as solvent gave rise to highly disordered nanotubular structure (FIG. 13). The mixture of water and ethylene glycol (33-50% water in EG) gave rise to ordered nanotubular structure having pore openings and tube lengths in the 50-60 nm and 1.0μ, respectively, in 7200 sec.

### Example 6

### Ultrasonic Mediated Anodization of Titanium

16 mm discs were punched out from a stock of Ti foil (0.2 mm thick, 99.9% purity, ESPI-metals, Ashland, Oreg., USA), washed in acetone, and secured in a polytetrafluoroethelene (PTFE) holder exposing only 0.7 cm² area to the electrolyte. Nanotubular TiO₂ arrays were formed by anodization of the Ti foils in 300 mL electrolyte solution of different concentrations of various electrolytes as described below.

A two-electrode configuration was used for anodization. A flag shaped Pt electrode (thickness: 1 mm; area: 3.75 cm²) served as cathode. The anodization was carried out at different voltages. The anodization current was monitored continuously. During anodization, an ultrasonicator was used to give mobility to the electrolytes, instead of a magnetic stirrer. The frequency applied during ultrasonication was approximately 40-45 kHz, with a frequency of about 42 kHz being preferred. The total anodization time was varied from 15 minutes to 75 minutes. The anodized samples were properly washed in distilled water to remove the occluded ions from the anodized solutions and dried in oven and fabricated for photocatalysis of water.

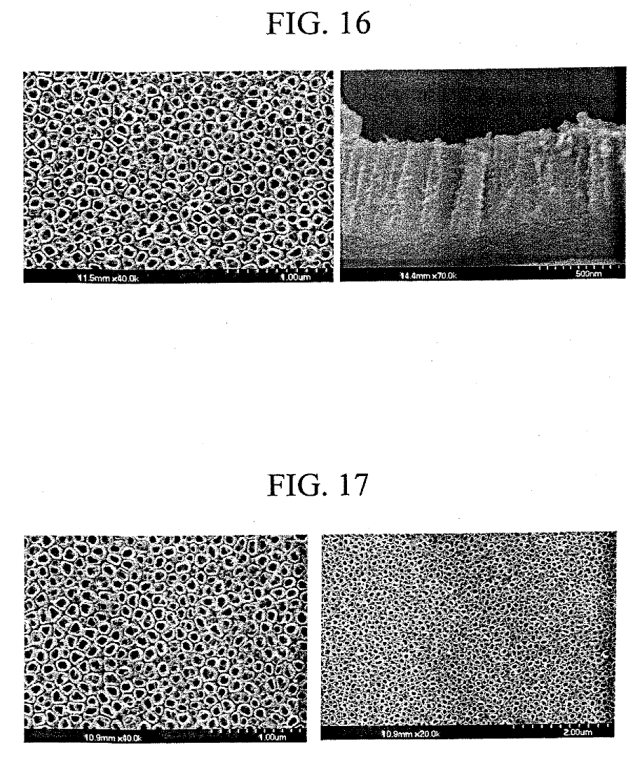

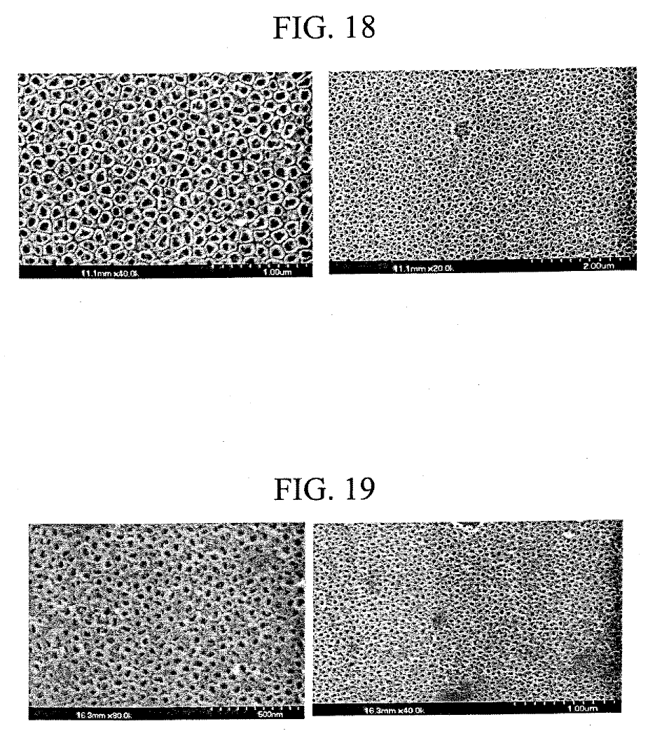

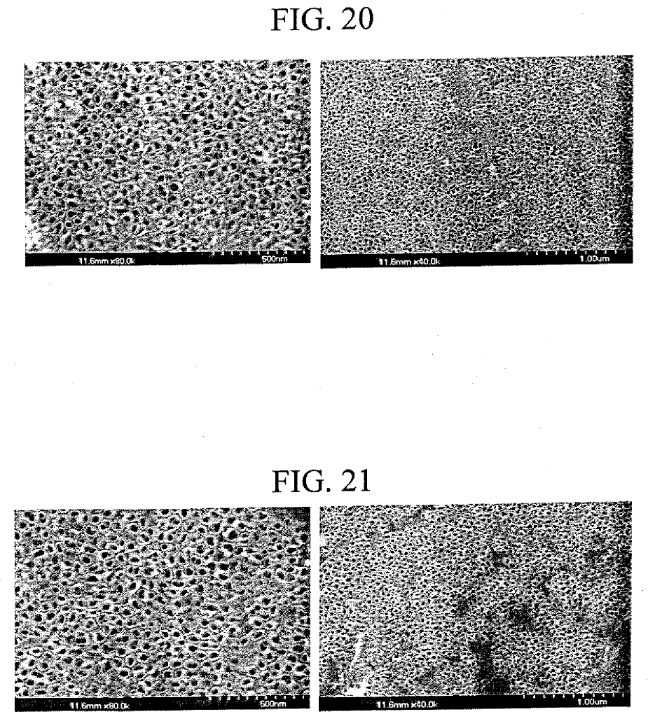

The various conditions used for anodization were as follows:
(a) Medium=Ultrasonic; Voltage=20V; Time=15 minutes; Solution amount=300 mL
   Electrolytes=(H₃PO₄:0.5M; NaF: 0.14M in distilled water)
   Pore size distribution=80-100 nm; Tube length=300-400 nm (SEM; FIG. 14).
(b) Medium=Ultrasonic; Voltage=20V; Time=30 minutes; Solution amount=300 mL
   Electrolytes=(H₃PO₄:0.5M; NaF: 0.14M in distilled water)
   Pore size distribution=80-100 nm (SEM; FIG. 15).
(c) Medium=Ultrasonic; Voltage=20V; Time=45 minutes; Solution amount=300 mL
   Electrolytes=(H₃PO₄:0.5M; NaF:0.14M in distilled water)
   Pore size distribution=80-100 nm; Tube length=600-700 nm (SEM; FIG. 16).
(d) Medium=Ultrasonic; Voltage=20V; Time=60 minutes; Solution amount=300 mL
   Electrolytes=(H₃PO₄:0.5M; NaF:0.14M in distilled water)
   Pore size distribution=80-100 nm (SEM; FIG. 17).
(e) Medium=Ultrasonic; Voltage=20V; Time=75 minutes; Solution amount=300 mL
   Electrolytes=(H₃PO₄:0.5M; NaF:0.14M in distilled water)
   Pore size distribution=80-100 nm (SEM; FIG. 18).
(f) Medium=Ultrasonic; Voltage=10V; Time=45 minutes; Solution amount=300 mL
   Electrolytes=(H₃PO₄:0.5M; NaF: 0.14M in distilled water)
   Pore size distribution=50-60 nm (SEM; FIG. 19).
(g) Medium=Ultrasonic; Voltage=10V; Time=45 minutes; Solution amount=300 mL
   Electrolytes ═(H₃PO₄:0.5M; NaF:0.07M in distilled water)
   Pore size distribution=40-50 nm (SEM; FIG. 20).
(h) Medium=Ultrasonic; Voltage=10V; Time=45 minutes; Solution amount=300 mL
   Electrolytes=(H₃PO₄:0.5M; NH₄F:0.14M in distilled water)
   Pore size distribution=50-60 nm (SEM; FIG. 21).

### Example 7

### Further Ultrasonic Mediated Preparation of Nano-Tubular Titania Substrates

The chemical used in this example include Phosphoric acid (H₃PO₄, Sigma-Aldrich, 85% in water); Sodium fluoride (NaF, Fischer, 99.5%); Potassium fluoride (KF, Aldrich, 98%); Ammonium fluoride NH₄F, Fischer, 100%), Ethylenediamine tetraacetic acid (EDTA, Fischer, 99.5%), and Ethylene glycol (EG, Fischer).

The nanoporous TiO₂ templates were formed by punching out 16 mm discs from a stock of Ti foil (0.2 mm thick, 99.9% purity, ESPI-metals, USA), which was washed in acetone and secured in a polytetrafluoroethylene (PTFE) bolder exposing only 0.7 cm² area to the electrolyte. Nanotubular TiO₂ arrays were formed by anodizing the Ti foils in a 300 mL electrolyte solution (0.5 M H₃PO₄+0.14 M NH₄F) using ultrasonic waves having a frequency of approximately 40-45 kHz, with about 42 kHz being preferred. A two-electrode configuration was used for anodization. A flag shaped Pt electrode (thickness: 1 mm; area: 3.75 cm²) served as a cathode. The anodization was carried out by the applied potential varying from 5V to 20V. During anodization, instead of a magnetic stirrer, ultrasonic waves were irradiated onto the solution to give the mobility to the ions inside the solution. The anodization current was monitored continuously. After an initial increase-decrease transient, the current reached a steady state value. The anodization was stopped after 20 minutes of reaching a steady state current value in lower pH electrolytes. The anodized samples were properly washed in distilled water to remove the occluded ions from the anodized solutions and dried in air oven and further characterized by scanning electron microscope (SEM; Hitachi, S-4700). Each of the above was mixed with ultrasonic waves.

### Example 8

### Photo-Anodes

To illustrate this invention, 1 cm² anodes, for example, were irradiated with solar spectrum of light and the cathode was uncoated Pt with 7.5 cm² surface area and was not exposed to extra-light irradiation, apart from room light. Generally, the surface area of the experimental photo-anodes ranged from 0.7 cm²-16 cm² and the Pt-cathode was about 10 cm². Using scaled up equipment larger area nano-tubular titanium dioxide-anodes can be prepared.

The light source was 300 W Xenon lamp manufactured by Newport Inc AM1.5 filter was used to simulate 1-sun intensity of ˜100 mW/cm². The incident light intensity on the anode was ˜87 mW/cm².

The photoanodes were investigated in the following conditions:
(a) Anodized nanotubular TiO₂ in 0.5 M H₃PO₄+0.14 M NaF solution, (as anodized).
(b) Anodized as above and annealed in N₂ atmosphere at 350° C. for 6 hours
(c) Anodized as in condition (a) and annealed in N₂ atmosphere at 500° C. for 6 h
(d) Anodized as in condition (a) and carbon doped at 650° C. for 5 minutes (C650/5 m)
(e) Anodized as in condition (a) and carbon doped at 650° C. for 10 minutes (C650/10 m)
(f) Anodized as in condition (a) and carbon doped at 650° C. for 15 minutes (C650/15 m)
(g) Anodized as in condition (a) and carbon doped at 650° C. for 20 minutes (C650/20 m)
(h) Anodized in 0.5 M NaNO₃+0.14 M NaF, pH 4 and 5+annealing at 350° C. in nitrogen for 6 h.

FIGS. 22-24 illustrate the results of photocurrent generated during solar light irradiation of the above photo-anodes. The potential of the nano-tubular titanium dioxide electrode was increased in the anodic direction from its open circuit potential to 1.2 V at a rate of 5 mV/s. The supply of external electrical energy (by applying anodic potential) was given to characterize the photoresponse of the TiO₂. In this case the photo-cathode was not irradiated by light. By irradiating both anode and cathode or by using acidic solution in cathode compartment and basic solution in anodic compartment the external supply of electrical energy can be eliminated or minimized for higher rate of hydrogen generation.

FIG. 22 illustrates the photocurrent generated at different potentials of the as-anodized TiO₂ electrode (conduction 1). FIG. 23 illustrates the photocurrent of nitrogen doped nano-tubluar TiO₂ electrode. Sample N350/6 h is the specimen annealed in nitrogen at 350° C. for 6 h and sample N500/6 h is annealed in nitrogen at 500° C. for 6 h. Dark current during application of potential (without irradiation) is included for comparison. FIG. 24 illustrates the photocurrents of carbon doped TiO₂.

FIG. 25 illustrates the photoconversion efficiency of carbon doped nanotubular photoanodes as a function applied electrical potential, and shows the photoconversion efficiency, η, of the photo-anodes at different applied potentials. The efficiency of the system increased with increased external potential, because both the photocurrent and the potential between photo-anode and cathode also increased. The hydrogen evolution at the cathode and oxygen evolution at the anode could be visibly observed when anode was irradiated with light in addition to applied potential. When the light was cut-off maintaining the external potential, the evolution of gases stopped immediately and the measured current dropped to less than 20 microampere level from few milliamperes.

If 1 mA/cm² current flows for one hour, the total volume of hydrogen evolved would be more than 0.4 ml. The maximum current observed in this invention was about 2.5 mA/cm² at 0.7 V(Ag/AgCl) potential using 1-sun light intensity. The hydrogen generation rate will be more than 10 liters/m² area of photo-anode per hour. This rate can be increased many folds by illuminating the photo-cathode also.

### Example 9

### Influence of Anodization Time

FIGS. 26-28 illustrate the monitored growth of nanotubes as anodization time increases. The anodizing solution used consisted of 0.5 M H₃PO₄ and 0.14 M NaF, and the anodization was carried out in room temperature (22-25° C.), with an anodization voltage of 20V. The growth of nanoporous TiO₂ tubes was monitored by FESEM (FIG. 26).

It can be seen from the figure that after 120 sec of anodization, small pits start to form on the surface of the titanium (FIG. 26). These pits increase in size after 600 sees, though still retaining the inter-pore areas. After 900 secs, most of the surface has covered with titanium dioxide layer, however the pores are not well distinct. The length of the oxide layer was found to be around 300 nm. After 1200 sec, the surface is completely filled with well-ordered nanopores. The outer pore openings were found to be in the range of 60-100 nm and the tube length around 700-750 nm. The walls of the nanopores were found to be 15-20 nm thick. The barrier layer (i.e., the junction between the nanotubes and the metal surface) is in the form of domes connected to each other (FIG. 27). Further, to find out the effect of time on these nanopores, the anodization time was further increased to 2700 sec and 4500 sec. It is observed that further increases in time, for example, to 7200 sec or 10800, do not affect the pore diameters or the lengths of the nanotubes. When completed under magnetic stirring, duplicate samples yielded a disordered pore surface after 1500 sec, and ordered nanotubes are formed only after 2700 sec (FIG. 28). The length of the nanotubes were found to be around 500 nm. Thus, by using ultrasonic waves for anodization, the synthesis time can be reduced by up to 50% and the length of the nanotubes also can be increased to 700-750 nm. It is also observed that ultrasonicated nanotubes are better ordered than the nanotubes prepared by magnetic stirring.

### Example 10

### Influence of Applied Potential

The uniformity and pore size of the nanotubes appears to improve as the applied potential increases. To confirm the effect of applied potential on the formation of nano-porous TiO₂ structures, data was collected for various applied potentials from 5V to 20V by keeping the electrolytic solution (0.5 M H₃PO₄+0.14 M HF) and time (2700 sec) constant, and conducting the anodization under ultrasonic waves. FIG. 31 indicates that an applied potential of 5V is not enough for the preparation of nanotubular TiO₂, and 10V is enough to prepare the nanotubular TiO₂. However, the uniformity and order of the pores increase when 15V and 20V is applied to the system. The average pore opening has also increased with the increase in applied potential. It is also interesting to note that nanotubes of 30-40 nm pore openings can be synthesized by applying 10V to an anodizing solution of 0.5 M H₃PO₄ and 0.07M HF (FIG. 31(d)). So the above observations show that the pore openings of the TiO₂ nanotubes can be tuned as per the requirements by changing the synthesis parameters like applied voltage and fluoride ion concentrations.

The following table shows the results obtained from the band gap and photocatalysis studies.

TABLE 2
Band gap and photocurrent of the electrodes
at external potential of 0.7 V.

| | Band gap (eV) | | Current (mA) | |
|---|---|---|---|---|
| Electrodes | Stirring | Ultrasonic | Stirring | Ultrasonic |
| Pure | 3.1 | 3.1 | 0.09 | 0.1 |
| Annealed under Ar | 3.1 | 3.1 | 1.3 | 1.2 |
| Annealed under N₂ | 3.0 | 2.9 | 1.6 | 1.08 |
| Carbon deposited | 2.5 | 2.5 | 2.4(1.2)^{#} | 2.5(2.2)^{#} (5)* |
| for 5 minutes | | | | |

^{#}at external potential of 0.5 V.
*at external potential of 1.3 V.

The results show that ultrasonic mediated anodization gives better result than the anodization by magnetic stirring. At lower applied potential ultrasonic samples gives almost similar photoactivity to the magnetic stirred samples at higher potential.

### Example 11

### Double Sided Anodization of Titanium

The electrode was prepared by taking a titanium foil of 1.5 cm² area, which was connected to copper wire through a small copper foil and conductive epoxy. It was then suspended in the electrolytic solution of 0.5M H₃PO₄ and 0.14M NaF in distilled water for 45 minutes and applied potential of 20V. It showed very good photo activity of 0.4 mA from each side, whereas single sided anodization used to show around 0.1 mA, without any treatment of the nanoporous titanium.

### Example 12

### Use of Different Fluoride for Preparation of TiO₂ Nanotubes Under Ultrasonic Treatment

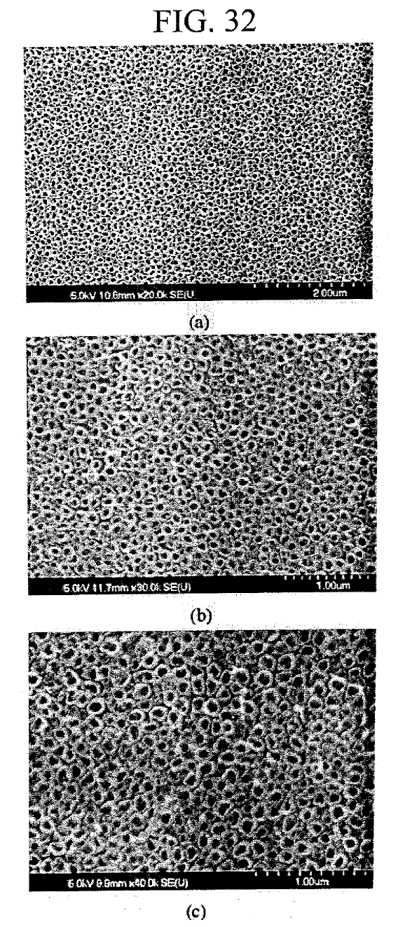

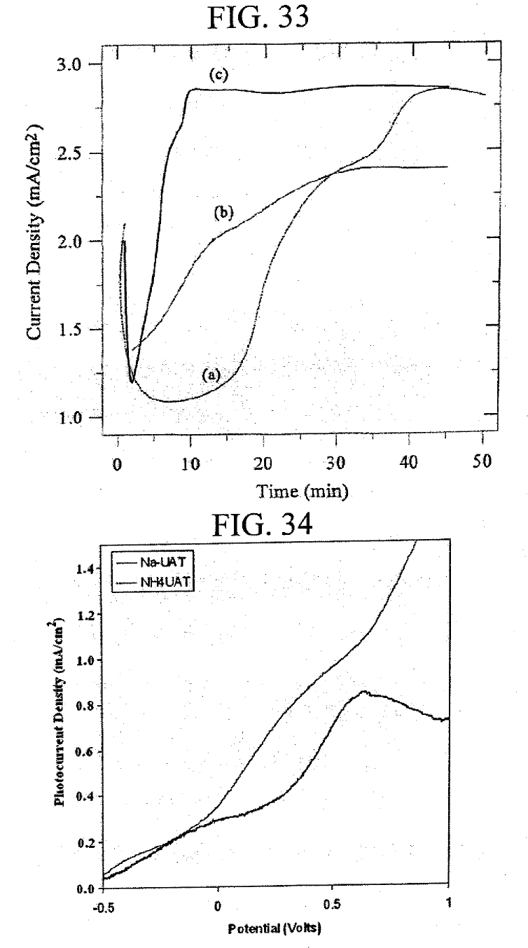

16 mm discs were punched out from a stock of Ti foil (0.2 mm thick, 99.9% purity, ESPI-metals, Ashland, Oreg., USA), washed in acetone and secured in a polytetrafluoroethelene (PTFE) holder exposing only 0.7 cm² area to the electrolyte. Nanotubular TiO₂ arrays were formed by anodization of the Ti foils in 300 mL electrolyte solution of phosphoric acid and different fluoride salts. A two-electrode configuration was used for anodization. A flag shaped Pt electrode (thickness: 1 mm; area: 3.75 cm²) served as cathode. The anodization was carried out at different voltage. The anodization current was monitored continuously. During anodization, ultrasonication was used to give mobility to the electrolytes, instead of a magnetic stirrer. The total anodization time was varied from 15 minutes to 75 minutes. The anodized samples were properly washed in distilled water to remove the occluded ions from the anodized solutions and dried in oven and fabricated for photocatalysis of water. SEM images (FIG. 32) showed different fluoride salts can be used for this purpose. The kinetics using NaF were faster than KF and NH₄F (FIG. 33; current vs time plot).

The various conditions used for anodization were as follows:
a. Medium=Ultrasonic; Voltage=20V; Time=30 minutes; Solution amount=300 mL
   Electrolytes=(H₃PO₄:0.5M; NaF:0.14M in distilled water)
   Pore size distribution=80-100 nm (SEM; FIG. 32(a)).
b. Medium=Ultrasonic; Voltage=20V; Time=30 minutes; Solution amount=300 mL
   Electrolytes=(H₃PO₄:0.5M; KF:0.14M in distilled water)
   Pore size distribution=80-100 nm (SEM; FIG. 32(b)).
c. Medium=Ultrasonic; Voltage=20V; Time 30 minutes; Solution amount=300 mL
   Electrolytes=(H₃PO₄:0.5M; NH₄F:0.14M in distilled water)
   Pore size distribution=80-100 nm; (SEM; FIG. 32(c)).

As is described above, various fluorides can be used to anodize titanium under ultrasonic treatment. NaF appears to be the most desirable for quick synthesis of the material, and NH₄F appears to be a better source than NaF when considered for photoelectrochemical generation of hydrogen (FIG. 34).

### Example 13

### Ethylene Glycol Mediated TiO₂ Nanotubular Arrays Synthesis

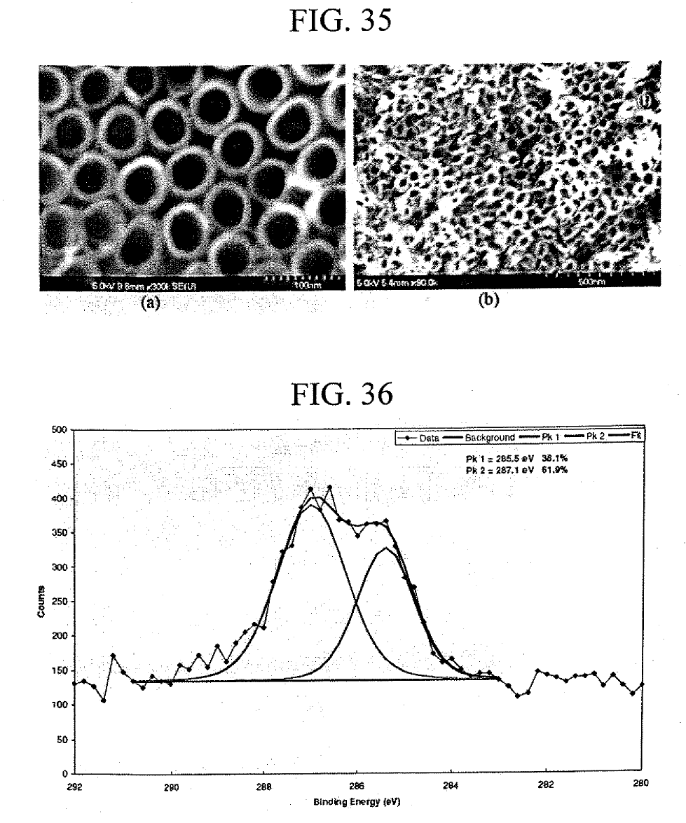

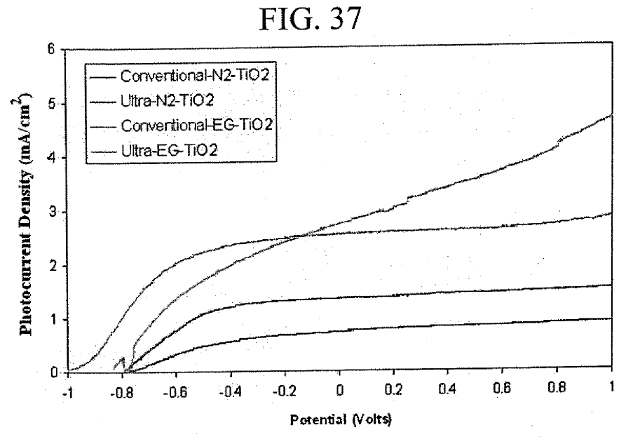

The combination of ethylene glycol and ultrasonic treatment yields very high quality ordered (hexagonal) nanotubes (FIG. 35a) with very small pore openings (20-40 nm). For example, when 0.5 wt % of ammonium fluoride was dissolved in 300 mL of ethylene glycol (EG) and was used as the electrolytic solution, the nanotubular length was found to be 1μ. For comparison, ethylene glycol was used under magnetic stirring condition (FIG. 35b). Ultrasonic mediated anodization, during which a frequency of approximately 40-45 kHz, with a frequency of about 42 kHz being preferred, was applied, took 1800 seconds where as using magnetic stirring it takes more than 3600 sec to prepare TiO₂ nanotubes. The same process can also be used for diluted ethylene glycol solution (in water) and diethylene glycol. XPS studies (FIG. 36) showed almost 66% of the carbon are bonded to Ti as carbonate species and thus helps to get better result for photo-electrochemical generation of hydrogen from water (FIG. 37). For a comparison, the results of N₂ treated TiO₂ materials were also given (Table 3).

TABLE 3
Photocurrent density of the prepared catalysts
using 0.2 V w.r.t standard Ag/AgCl electrode.

Photo current density (mA/cm²)

| Sample code | Ultrasonic | Conventional |
|---|---|---|
| N₂—TiO₂ | 1.35 | 0.8 |
| EG-TiO₂ | 3.6 | 2.7 |

As is described above, good quality nanotubes can be prepared from ethylene glycol, diluted ethylene glycol and diethylene glycol under ultrasonic media. Various fluoride sources can be used but as the solubility of NH₄F in glycol media is better than the others, NH₄F is a better source in organic media. It is also observed that the photoactivity of ultrasonic treated materials is higher than the conventional magnetic stirring method.

### Example 14

### Photoelectrochemical Cell for Generating Hydrogen

FIG. 6 schematically illustrates an exemplary photoelectrochemical cell for generating hydrogen in accordance with the invention. The photochemical cell includes a glass cell having separate compartments for photo-anode (nanotubular TiO₂ specimen) and cathode (platinum foil). The compartments can be connected by a fine porous glass frit. A reference electrode (Ag/AgCl) may be placed close to the anode using a salt bridge (saturated KCl)-Luggin probe capillary. The cell was provided with a 60 mm diameter quartz window for light incidence. The electrolytes used were 1 M NaOH, 1 M KOH (pH˜14), 0.5 M H2SO4 (pH˜0.3) and 3.5 wt % NaCl (pH˜7.2) aqueous solutions. Electrolytes were prepared using reagent grade chemicals and double distilled water. No aeration or de-aeration was carried out to purge out the dissolved gases in the electrolyte. A computer-controlled potentiostat (Model: SI 1286, Schlumberger, Famborough, England) was employed to control the potential and record the photocurrent. A 300 W solar simulator (Model: 69911, Newport-Oriel Instruments, Stratford, Conn.) was used as a light source. The light at 160 W power level was passed through an AM1.5 filter. Photo electrochemical studies were carried out in different combinations of band pass filters: 1. AM 1.5 filter 2. AM 1.5+UV filter (250-400 nm, Edmund Optics, U330, center wave length 330 nm and FWHM: 140 nm) and 3. AM 1.5+visible band pass filter (Edmund Optics, VG-6, center wave length 520 nm and FWHM:92 nm). The intensity of the light was measured by a radiant power and energy meter (Model 70260, Newport Corporation, Stratford, Conn., USA) and a thermopile sensor Model: 70268, Newport). The incident light intensities without any corrections were 174, 81 and 66 mW/cm2 with AM 1.5 filter, AM 1.5+UV filters, and AM 1.5+VIS filters respectively. The samples were anodically polarized at a scan rate of 5 mV/s under illumination and the photocurrent was recorded. The potential of photo-anode and cathode also was recorded for calculation of photo conversion efficiency.

### Example 15

### Photocurrent-Potential Characteristics of Annealed Phosphate Containing TiO₂ Nanotubes

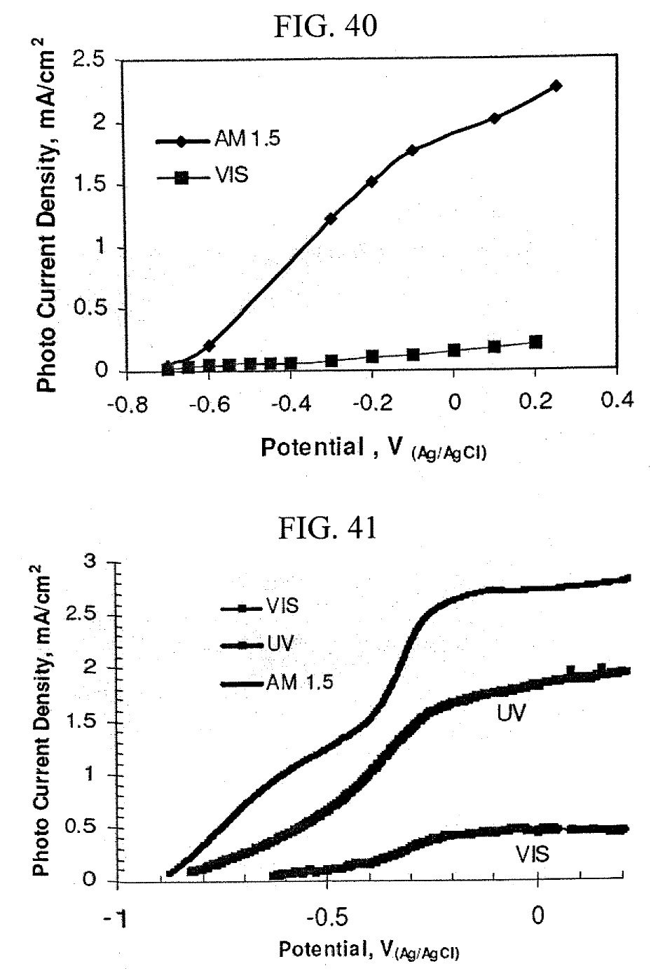

FIG. 40 shows the photocurrent-potential characteristics of the annealed phosphate containing TiO₂ nanotubes illuminated only in the visible light having a center wavelength (CWL) at 520 nm and FWHM of 92 nm. In the absence of the UV component, the photo activity of the TiO₂ nanotubes decreased considerably. The photocurrent density at a bias potential of 0.2 V was about 0.2 mA/cm². It should be noted this value was higher than the value reported for nitrogen doped nanotubes with a similar bias condition.

### Example 16

### Photocurrent Results of Carbon Modified TiO₂ Samples as a Function of Applied Potential

FIG. 41 shows the photocurrent results of carbon modified TiO₂ samples as a function of applied potential. When the UV component was filtered out from the solar light, the composite electrode showed a photocurrent density of 0.45 mA/cm² under the applied anodic potentials. The photo current density measured in the visible light (without UV) illumination was similar to that reported by Bard and coworkers for the TiO₂₋ₓCₓ material prepared by a different route.

Composite electrode of the carbon modified nanotubular TiO₂, which was anodized in H₃PO₄+NaF and then carbon doped at 650° C. for approximately 5 minutes, showed a photocurrent density of 2.75 mA/cm² under sunlight illumination at higher anodic potentials. This photocurrent density corresponds to hydrogen evolution rate of 11 liters/hr on a photo-anode with 1 m² area. The gases evolved in the cathode and anode compartments were analyzed separately using gas chromatography and the ratio of hydrogen to oxygen was 2:1, indicating that carbon in the carbon-modified TiO₂ sample was stable. Further, the hydrogen generation was stable for more than 72 hours. The long-term test was interrupted because of the limited life of the lamp. The carbon-modified TiO₂ nanotubular samples with 0.5-16.0-cm² geometric surface areas were evaluated and the photo current density remained constant irrespective of the surface area of the anode.

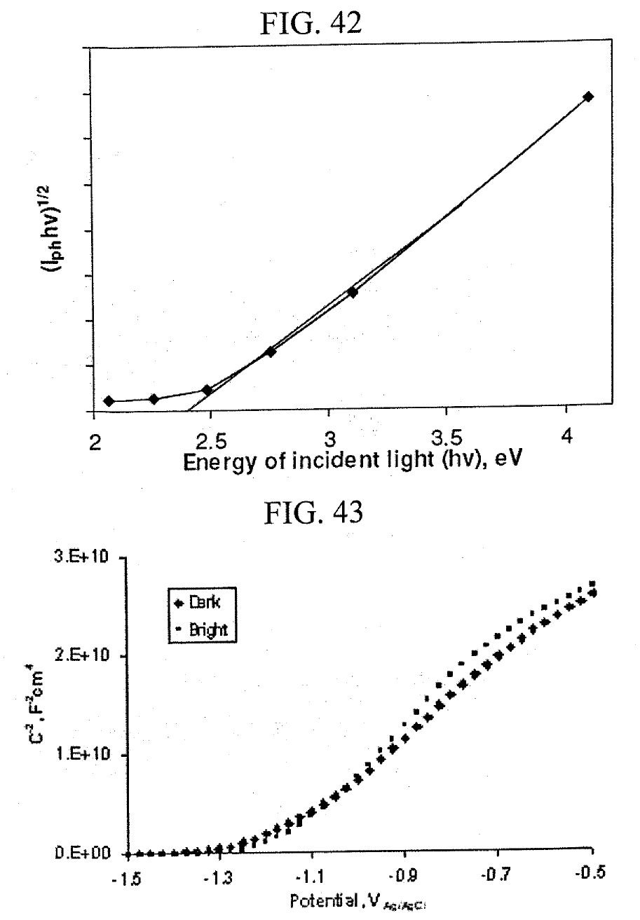

FIG. 42 shows the results of band-gap determination based on the photo current (Iₚₕ) values as a function of the light energy. A linear relation could be observed between (Iₚₕhv)^{1/2} and hv indicating the transition was indirect. From the figure, the band gap of the carbon modified TiO₂ nanotubular arrays could be considered <2.4 eV. The energy of the light was varied by employing band pass filters in steps of 50 nm in the visible region. Therefore, the accuracy of the determination of the band transition energy level was limited. The photoelectrochemical behavior of the samples is in line with the optical absorbance results, even though it is established that band-gap modification alone does not result in increased photo-activity.

The carbon modified samples, which were anodized in H₃PO₄+NaF and then carbon doped at 650° C. for approximately 5 minutes, showed a better photoelectrochemical behavior than the inert atmosphere annealed samples. This improved behavior could be attributed to possibly two reasons, viz, 1. band gap states introduced by carbon and 2. presence of trivalent Ti interstitials and oxygen vacancy states introduced by the reducing environments. In this study, enhanced absorption in the visible wavelength suggests that carbon modification resulted in local band gap states. High-resolution XPS studies carried out on the nitrogen/hydrogen annealed samples and carbon modified TiO₂ nanotubular samples suggested presence of Ti³⁺ species. The presence of Ti³⁺ cations in the TiO₂ should be associated with oxygen vacancies in order to maintain the electro-neutrality.

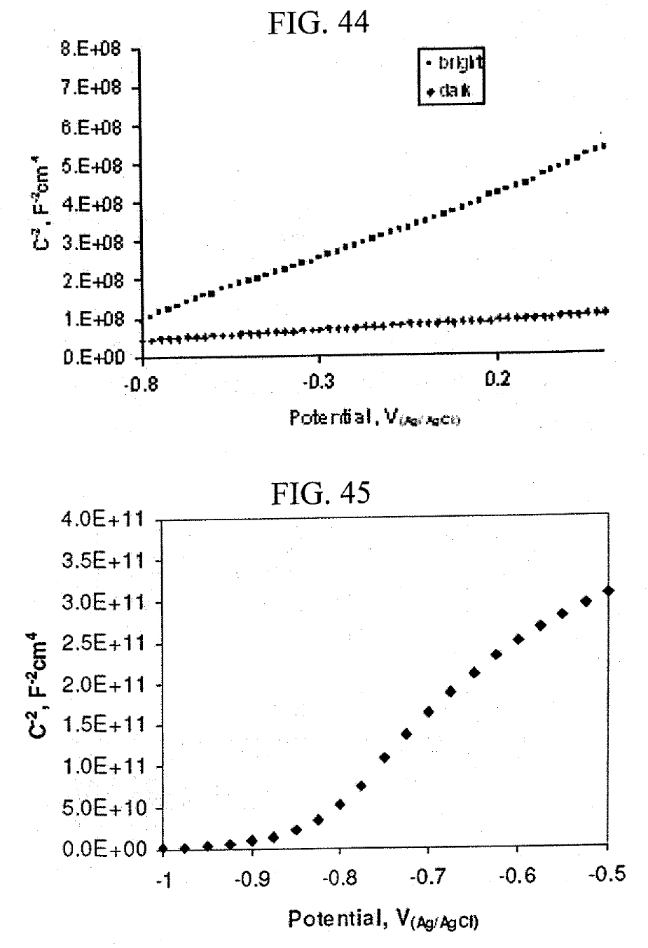

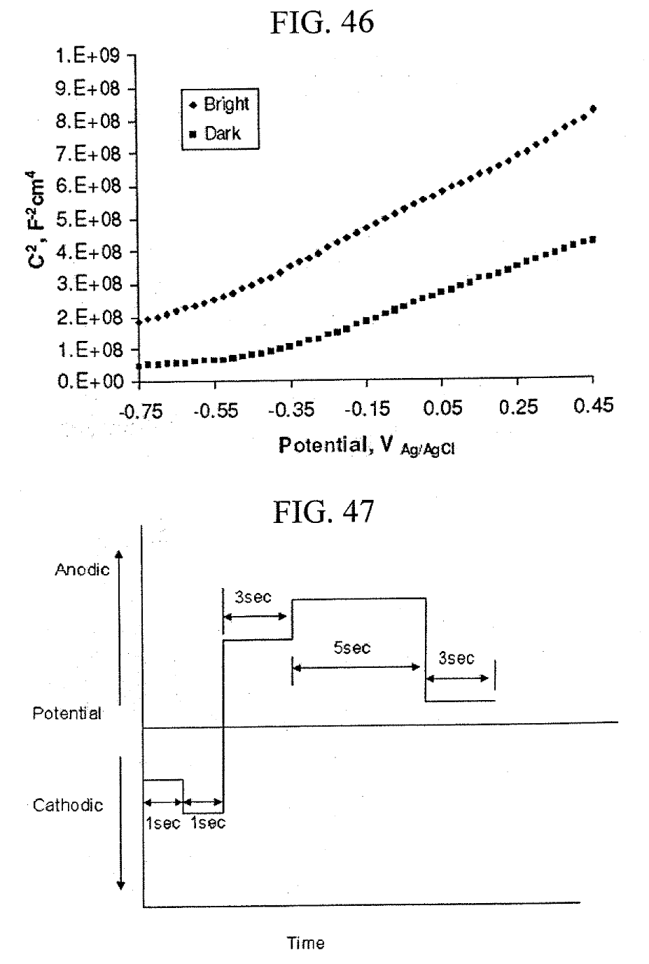

The TiO₂ nanotubes of the invention are considered to be n-type semiconductors. Mon-Schottky results also show the n-type behavior, as shown in FIGS. 43-46. The Mott-Schottky analysis was carried out in both dark (room light illumination) and illuminated conditions (by the simulated solar light). FIGS. 43-44 show the potential vs 1/C² relation for as-anodized and N₂-annealed nanotube arrays, for comparison. The as-anodized sample was anodized in H₃PO₄+NaF, and the N₂-annealed sample was annealed in N₂ at 650° C. for 5-10 minutes. The charge carrier density can be calculated from the slope of the linear portion of the Mott-Schottky plots. According to the Mott-Schottky relation, the charge carrier density is given as N_{D}=2/(e*ε*ε₀*m); (where e=elementary electron charge, ε=dielectric constant, ε₀=permittivity in vacuum and m=slope of the E Vs 1/C² plot). This relation indicates that smaller the value of the slope higher will be the charge carrier density.

The charge carrier densities, calculated based on the Mott-Schottky analyses, were in the range of 1-3×10¹⁹ cm⁻³ for both the carbon modified and the nitrogen-annealed nanotubular samples. The charge carrier densities of as-anodized and oxygen-annealed samples were 5×10¹⁷ and 1.2×10¹⁵ cm⁻³ respectively. There was no significant difference (not in the orders of magnitude) in the charge carrier densities between the dark and the illuminated conditions except for the N₂-annealed specimens. The reason could be attributed to the smaller percentage of UV portion of the incident light. UV irradiation is thought to improve the hydrophilic nature of the TiO₂ by creating Ti³⁺ states and oxygen vacancies. In this way, the charge carrier density could increase by UV light illumination. If oxygen vacancies were produced during annealing in nitrogen or hydrogen atmosphere, the charge carrier density would be expected to increase, and this expected increase in charge density after the annealing treatments could be attributed to the oxygen vacancies introduced after annealing in the inert or reducing environments. However, the methods of the invention instead showed a decrease in the charge carrier density upon light illumination, and the flat band potentials did not change significantly. In addition, it was shown that the measured photo current density was not directly related to the charge carrier densities of the nanotubes, because the photo current density generated by the O₂-annealed specimens (˜1.4 mA/cm²) was significantly higher than that of the as-anodized specimens in spite of the considerably lower charge carrier density. The presence of different phases, such as amorphous, anatase, and Futile, appear to influence the photo activity more than the charge carrier density.

### Example 17

### Method of Coating CdTe or CdZnTe Nanowires/Thin Films

0.001 to 0.01 M CdCl₂+0.0001 to 0.0005 M TeCl₄ (for coating CdTe) or 0.001 to 0.01 M CdCl₂+0.001 to 0.01 M ZnCl₂+0.0001 to 0.0005 M TeCl₄ (for coating CdZnTe) salts were dissolved in 1 liter of propylene carbonate. All salts are reagent grade and anhydrous. The electrolyte was heated to 80-140° C., with a temperature of about 130° C. being most preferred.

A three electrode configured electrochemical cell was used for deposition of Cd—Te and Cd—Zn—Te nanowires/thinfilms. Advantageously, the invention deposits Cd—Zn—Te nanowires/thinfilms in a single step. As a non-aqueous solvent is used for electrodeposition, moisture and oxygen are controlled less than 1 ppm in the electrochemical cell. This was ensured by carrying out all the activities such as preparation of the electrolyte and electrodeposition inside a dry-controlled atmosphere chamber. A glove box purged with dry, high-purity argon gas is used for this purpose. The dry and oxygen free atmosphere is ensured by measuring the burning life of a perforated 25 W filament light bulb. If the bulb burns for more than two hours exposing the filament to the atmosphere of the glove box, the oxygen and moisture contents of the chamber are assumed to be less than 1 ppm.

Electrodeposition of CdTe and CdZnTe are carried out by pulsing the potentials between pre-determined deposition potentials and 200 mV anodic to open circuit potentials. These potentials were determined from the cyclic voltammetry studies. The deposition potentials ranged from −0.3 to −1.2 V with reference to Cd wire reference. Anodic potentials ranged from 0.1 to 0.5 V with reference to Cd wire. The pulsing (deposition) time ranged from 0.1 to 1 second. The background (anodic potential) time ranged from 2-10 seconds. The total cycle time of deposition process varies from 45 minute to 2 hour depending on the final thickness of the nanowire coating. The electrodeposition was carried out at 80-140° C.

The reference electrode used is a pure Cadmium wire of 1 mm diameter and 200 mm long immersed in propylene carbonate solution containing 0.01 M CdCl₂ salt. The reference electrode compartment has a 10 mm diameter and 150 mm long glass tube with type E fine pores ceramic fritted end. The counter electrode is a flag type Pt foil with 10 cm² area.

Electrodeposition of CdTe/CdZnTe on anodized Ti samples resulted in formation of nanowires nucleating from bottom of the nanotubes of TiO₂. On Pt foils, electrodeposition resulted in thin films of CdTe/CdZnTe.

Energy Dispersive Analysis of X-Ray results indicated the composition of the CdZnTe nanowires to be 44 atomic % Cd, 8 at % Zn and 48 at % Te. CdTe coatings contained stoichiometric amounts of Cd and Te.

After the electrodeposition the coating is thoroughly washed in anhydrous methyl alcohol and dried. Then, the coating is annealed at 400-500° C. in flowing high purity argon gas atmosphere for 1-3 hours. After annealing, the sample is ready as photo-cathode.

### Example 18

### Templated Growth of Cadmium Zinc Telluride (CdZnTe) Nanowires

CdTe and CdZnTe compound semiconductors are used widely in infra-red (IR), X-ray and gamma ray radiation detection applications and in solar cell panels. CdZnTe is considered more advantageous than CdTe in radiation detection because of wider band gap and higher resistivity, which renders low noise level. Preparation of CdZnTe in the form of nanowire arrays facilitates the use of large area detectors with minimized trap centers.

Therefore, a single step electrochemical method of synthesis of cadmium zinc telluride (CdZnTe) nanowires using nanoporous TiO₂ template was developed using propylene carbonate (PC) as a non-aqueous electrolyte. Pulsed cathodic and anodic potentials resulted in growth of nanowires of CdZnTe with p-type semiconductivity. More negative cathodic potentials increased the Zn content. Increase in Zn content increased the charge carrier density of the nanowires. Annealing of the material at 350° C. for 1 h decreased the charge carrier density to the order of 10¹⁵ cm⁻³. Cyclic Voltammogram studies were carried out to understand the growth mechanism of CdZnTe. EDAX and XRD measurements indicated formation of a compound semiconductor with a stoichiometry of Cd₁₋ₓZnₓTe, where x varied between 0.04 and 0.2. Variation of the pulsed-cathodic potentials could modulate the composition of the CdZnTe. More cathodic potentials resulted in increased Zn content. The nanowires showed an electronic band gap of about 1.6 eV. Mott-Schottky analyses indicated p-type semiconductor properties of both as-deposited and annealed CdZnTe materials. Increase in Zn content increased the charge carrier density. Annealing of the deposits resulted in lower charge carrier densities, in the order of 10¹⁵ cm⁻³.

The titanium dioxides used were prepared by anodizing high purity titanium foils (0.1 mm thick, 99.999 wt % purity, ESPI-metals, Ashland, Oreg., USA). The surface area exposed for anodization was around 0.7 cm². The anodization was carried in a solution of 0.5 M phosphoric acid, 0.14 M sodium fluoride and pH of 2.0. Anodization was carried out at 20 V and 25° C. for about 45 minutes. The resultant product obtained was nanoporous titanium dioxide with a pore diameter of 100 nm and pore length of 400-500 nm.

The non-aqueous medium used for deposition was propylene carbonate (PC). Propylene carbonate was chosen as a solvent because of its higher dielectric strength (65), higher dipole moment and charge acceptor number. Cyclic voltammetry (CV) studies were carried out to understand the growth mechanism's of CdZnTe. Both platinum and anodized nanoporous TiO₂ were used as electrodes during cyclic voltammetry. The following electrolytes were used for cyclic voltammetry (CV) studies:
(a) 25×10⁻³ M NaClO₄ in PC
(b) 5×10⁻³ M CdCl₂+25×10⁻³ M NaClO₄ in PC (Referred as Cd solution)
(c) 0.5×10⁻³ M TeCl₄+25×10⁻³ M NaClO₄ in PC (Referred as Te solution)
(d) 5×10⁻³ M CdCl₂+0.5×10⁻³ M TeCl₄+25×10⁻³ M NaClO₄ in PC (CdTe solution)
(e) 5×10⁻³ M CdCl₂+10×10⁻³ M ZnCl₂+0.5×10⁻³ M TeCl₄+25×10⁻³ M NaClO₄ in PC (CdZnTe solution)
(f) 1,10,25×10⁻³ M ZnCl₂+0.5×10⁻³ M TeCl₄+25×10⁻³ M NaClO₄ in PC (Zn variance in ZnTe solution)
(g) 5×10⁻³ M ZnCl₂+18×10⁻³M CdCl₂+0.5×10⁻³ M TeCl₄+25×10⁻³ M NaClO₄ in PC (Cd variance in CdTe solution)
(h) 5×10⁻³ M ZnCl₂+5×10⁻³ M CdCl₂+0.1, 0.5 and 1.0×10⁻³ M TeCl₄+25×10⁻³ M NaClO₄ in PC(CdZnTe solution with Te variation)

Both the CV and electrochemical deposition of CdZnTe nanowires were carried out in a three-electrode cell at 95±2° C. CV tests were carried out using both Pt and nanoporous TiO₂ substrates at a potential sweep rate of 10 mV/s. 5 cm² platinum foil in the shape of a flag was used as a counter electrode. A pure cadmium wire immersed in PC solution saturated with CdCl₂ and contained in fritted end glass tube acted as a reference electrode. Here after this reference electrode will be referred as a cadmium wire reference electrode. Anodized titanium dioxide sample was used as the template for nanowire growth. 25×10⁻³ M NaClO₄ was used as the supporting electrolyte. All depositions were carried out in a controlled atmosphere inside a glove box (Labconco, Model 50600-00). Ultra high purity argon was used as the inert atmosphere. The oxygen and moisture contents of the glove box were controlled at low levels so that a pierced 25 W incandescent bulb could burn at least for an hour inside the glove box environment, Nanowires of CdZnTe were deposited on the nanoporous TiO₂ template by pulsing the potentials. A typical pulsed-potentials cycle contained two cathodic, two anodic and one open circuit potential, as depicted in FIG. 47. All potentials were applied with respect to the cadmium reference electrode. Cathodic pulsed potential used varied between −0.4V to −1.2 V and pulsed for 1 second. The anodic pulsed potentials were kept constant in all the test runs. The two anodic potentials used were 0.3V for 3 secs and 0.7V for 5 secs. The deposition time was typically around 30 minutes. Potentials were applied using a computer controlled potentiostat (Schlumberger, Model: SI-286, Famborough, England) and Corrware software (Solartron). Once the depositions were done the samples were rinsed with anhydrous semiconductor grade methanol and dried in vacuum. The samples were then annealed at 350° C. in a CVD furnace in high purity argon atmosphere (200 cc/minute) for 1 hr. The annealed samples were cleaned with methanol and the samples were then characterized.

Scanning electron microscopy (SEM) and glancing angle X-ray powder diffraction (XRD) measurements were used to characterize the nanowires of CdZnTe. The chemical compositions of the nanowires were characterized by X-Ray energy dispersive analysis (EDAX). Further resistance measurements of the deposited film were also measured.

A Mott-Schottky analysis was carried out on the sample to study the electronic properties of the deposited films in annealed and as deposited conditions. The analysis was carried out in a 0.5 M sodium sulfate solution by adjusting pH to 2.0. Potential of the sample was scanned from +1 to −1 V with a scan step rate of −50 mV/s. The frequency used was 3000 Hz. The interfacial capacitance C was calculated by the system software (Z-Plot, Solartron) using the relation C=(−(1+D²)*Z″2πf)⁻¹, in case of parallel capacitance circuit assuming presence of surface states at oxide-semiconductor interface or C=−1/(2πfZ″) in case of series capacitance; where, D=Z′/Z″, Z′=real part of impedance, Z″ is the imaginary part of the impedance and f is the frequency. Capacitance C is related, in turn, to the charge carrier density, N_{A}, by the following equation:

$$\frac{1}{{C}^{2}} = \frac{2}{e {ɛɛ}_{0} {N}_{A}} [ E - {E}_{FB} - \frac{KT}{e} ] \qquad ( 1 )$$

Where e=elementary electron charge (positive for n-type and negative for p-type), ε₀=permittivity in vacuum, ε=dielectric constant (11 for CdZnTe and 86 for TiO₂), N_{A}=charge carrier density, E=applied potential, E_{FB}=flat band potential, K=Boltzmann constant, T=temperature.

According to Equation 1, the slope of 1/C² vs. potential plot gives the charge carrier density, N_{A}, from the relation:

$${N}_{A} = \frac{2}{e {ɛɛ}_{0} m} \qquad ( 2 )$$

Where m is the slope of the Mott-Schottky plot in the region of interest. A positive slope indicates n-type semiconductor and a negative slope p-type. The intercept 1/C²=0 on the potential axis gives the flat band potential E_{FB}. All potentials were measured with respect to the Ag/AgCl reference electrode in saturated KCl.

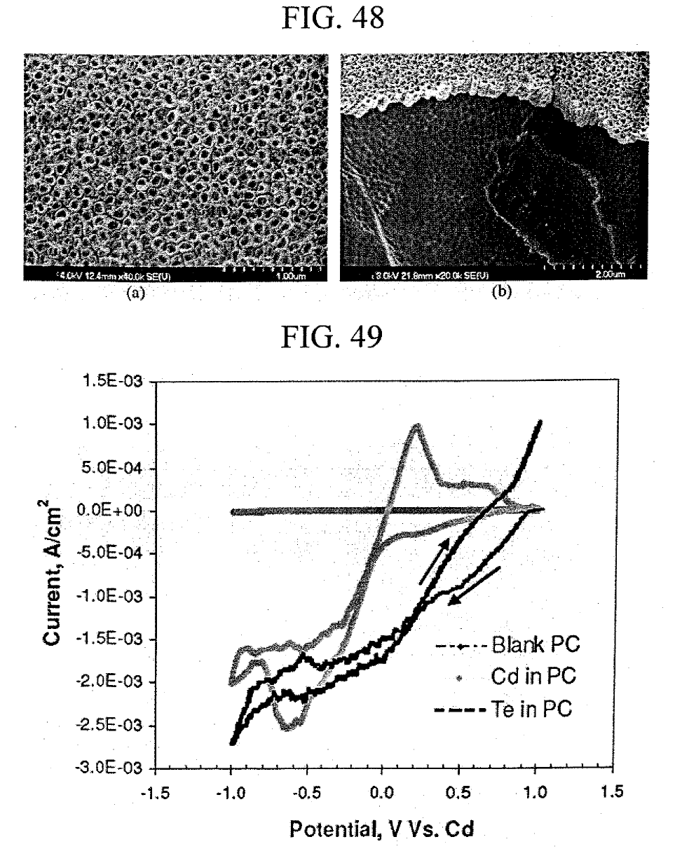

FIG. 48 shows the nanoporous morphology of the anodized titanium template used for the growth of CdZnTe nanowires. Diameter of the nanopores was 70-100 nm and the length varied between 400-500 nm.

### Example 19

### CV on Pt substrate

FIG. 49 shows the results of CV carried out in different non-aqueous solutions on the Pt surface. The potentials were with reference to Cd wire immersed in PC solution saturated with CdCl2 in a separate fritted-compartment at test temperature. The potential of this reference electrode was −0.425 V with reference to an external room temperature Ag/AgCl reference electrode. In the blank run without addition of any salt, the anodic and cathodic current peaks were not observed. This shows that the electrolyte was stable at the potential regions between −1.0V to 1.5 V (Cd). It is reported that PC has an electrochemical window of −2.2 V to +2.3 V (Ag/AgCl). Oxidation of ClO₄⁻ occurs at potentials above 1.5V (Ag/Ag⁺). In Cd solution the cathodic current observed below a potential of −0.08V. On the reverse scan anodic peak was observed at 0.22V. This peak is attributed to the stripping of Cd. In Te solution, cathodic current started to occur at potential more negative to +0.9V vs. Cd. In aqueous solutions the reduction potential of the reaction Te⁴⁺+4e⁻→Te was considered as 0.328V vs. SCE (0.573V vs. NHE) which is about 0.97V more positive than the reduction potential of Cd²⁺+2e⁻→Cd. When considering a six electron reduction process: Te⁴⁺+6e⁻→Te²⁻ E⁰=0.046V_{SCE}=0.291V_{NHE}

This is about 0.7V more positive to that Cd²⁺/Cd reaction. Therefore, the cathodic currents can be attributed to the reduction of Te from the non-aqueous solution. Similarly anodic peaks occurred more positive to 0.7V which corresponded to the reverse reactions: Te²⁻→Te+2e⁻, and Te→Te⁴⁺+4e⁻.

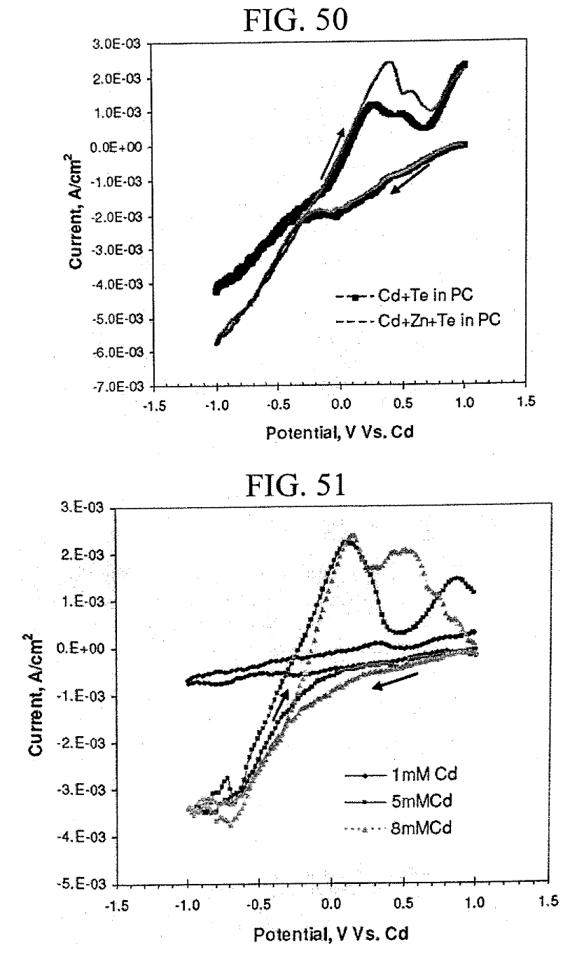

In CdTe solutions a cathodic current was observed at potentials more negative to +0.9V and at +0.4 V a change in the slope of cathodic current occurred as shown in FIG. 50. From the current magnitude in comparison with that of Te solution, it can be suggested that only pure Te deposited at potentials between +0.9V and +0.5 V in CdTe solution. At potentials between 0.5 V and 0 V vs. Cd, it is suggested that there is under potential deposition of Cd in addition to the deposition of Te. Formation of CdTe compound cannot be ruled out because of favorable free energy conditions. The mechanism of CdTe deposition can be suggested as occurrence of the following two reactions:

Te+2e⁻→Te²⁻

Cd²⁺+Te²⁻→CdTe

These reactions suggest that already reduced Te species act as sites for CdTe deposition. At potentials more negative to 0 V, the Cd²⁺ ions also compete for electrons for electro reduction reaction of Cd²⁺+2e⁻→Cd. Therefore there was a current plateau with increase in potential between 0 and −0.2V. The plateau region indicates slower kinetics of deposition at these potentials, which could be attributed to the competition for adsorption sites for deposition of either CdTe or Cd. At more negative potentials, the cathodic increased with steeper slope which could be attributed to additional deposition of Cd along with CdTe.

Reversing the CV sweep in anodic direction resulted in two faint peaks at +0.26V and +0.5V. The first peak was similar to the anodic stripping of Cd observed in pure Cd solution and the second peak could be labeled as the dissolution of Cd from the CdTe compound lattice. Third anodic peak at more positive potential than 0.66V is attributed to the stripping of Te.

Cyclic voltammetry in CdZnTe solutions was more or less similar to the results of CdTe as shown in FIG. 50. The initial cathodic current waves were similar to that of CdTe indicating that at more positive potentials only Te got reduced and at less positive potentials deposition of CdTe occurred in spite of Zn addition in the solution. When the potential was more negative than 0 V vs. Cd, almost similar plateau region was observed as observed in the case of CdTe solution. However, the cathodic current increased at less cathodic potentials in CdZnTe solutions as compared to that in CdTe solution, indicating possible compound formation at much positive potential with reference to the reduction potential of Zn. From the values of free energy of CdTe (−92KJ/mol) and ZnTe (−141.6KJ/mol) it can be argued that free energy of formation of CdZnTe lies between these values. Therefore, the increased cathodic current at lower cathodic potentials (as compared to that of CdTe solution) could be because of additional reduction of Zn to form a CdZnTe compound which consumed more charge than CdTe deposition. During anodic sweep, 3 anodic peaks were observed as in the case of CdTe.

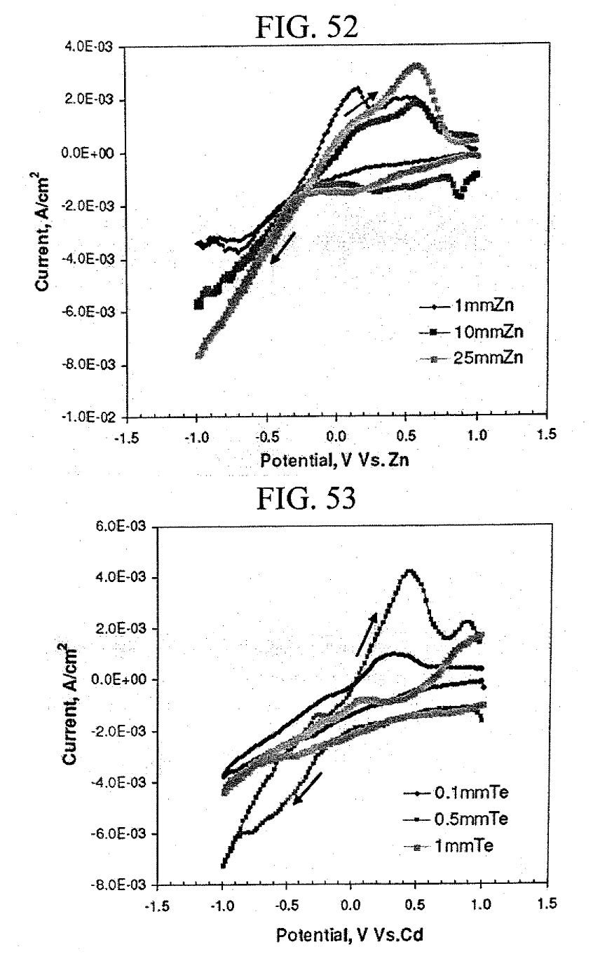

The peak current potentials were shifted positively as compared to that of CdTe stripping. Significant similarities were observed between CV of CdTe and ZnTe as shown in FIGS. 51 and 52. The CV in ZnTe solution was carried out with reference to a Zn wire reference electrode. When calibrated against Ag/AgCl reference electrode the potential of Zn wire reference electrode was −0.515 V, about 90 mV negative to that of Cd wire reference electrode. The cathodic reduction wave of ZnTe was observed at −0.274 V Zn (−0.364 V against Cd). The reduction wave of CdTe also was observed in the vicinity of this potential as shown in FIG. 51 indicating that both CdTe and ZnTe could deposit simultaneously. Similar to that of CdTe deposit, ZnTe also revealed two anodic stripping peaks at 0.15 V and 0.57 V vs Zn. In case of CdTe the anodic peaks were at 0.26 and 0.5 V vs Cd. Converting these potentials to Zn scale, it can be observed that the first anodic peak of ZnTe was about 0.2 V negative to that CdTe stripping; whereas, the second anodic peak of ZnTe almost coincided with the second anodic peak of CdTe. FIG. 53 shows the CV of CdZnTe solution with varying amounts of Te. Addition of 0.1×10-3 M TeCl₄ did not result in stoichiometric telluride deposits as observed by post-deposition EDAX analysis. 1×10⁻³ TeCl₄ solution resulted in deposits enriched with Te as observed from the anodic portion of CV. From the cyclic voltammogram and EDAX analyses (not shown here), it was observed that addition of 0.5×10⁻³ M TeCl₄ to 5×10⁻³ M CdCl₂+10×10⁻³ M ZnCl₂ solution resulted in stoichiometric cadmium zinc telluride deposits.

### Example 20

### CV on TiO₂ Substrate

When the CV was carried out on anodized TiO₂ surface, not much difference was observed with the behavior of cathodic current waves. However, the anodic behavior was quite different with TiO₂ nanoporous surface. In TiO₂ surface only one anodic peak was observed, which occurred at 0.34V vs. Cd. This peak can be similar to the first anodic peak observed on Pt surface at 0.39V.

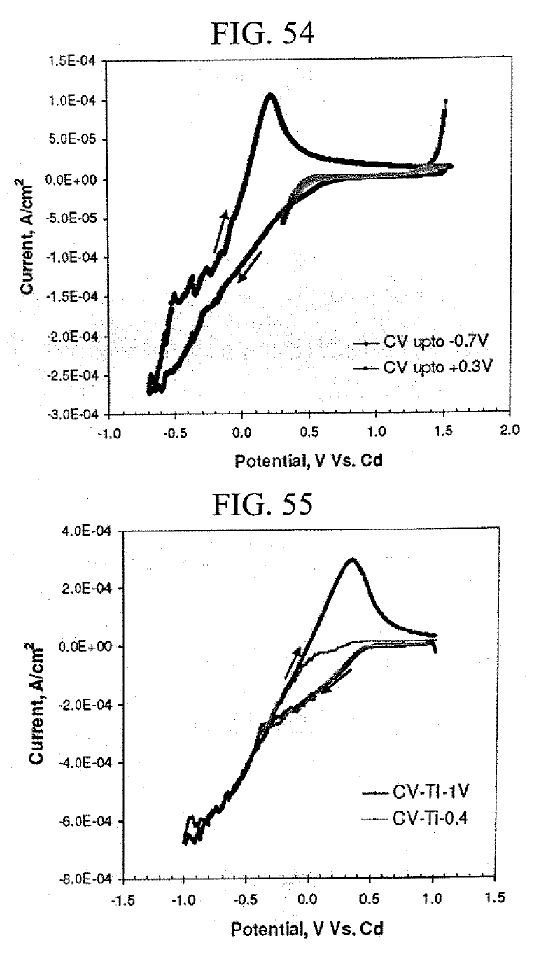

In order to understand the origin of the anodic strip, CV was carried out in CdZnTe solutions on TiO₂ surface by switching the scan directions at various potentials. When the forward (Cathodic potential) was switched (reversed) after reaching +0.3V and −0.4V, no specific anodic peak current was observed as shown in FIGS. 54 and 55. However there was dissolution as anodic currents were observed at potentials more than 0.5V. The dissolved species could be CdZnTe compound and Te. When the anodic polarization extended till 1.5 V vs. Cd, a rise in anodic current was observed at potential more positive to 1.2V in case of +0.3V switching potential. For −0.7V switching potential (FIG. 55) the anodic peak occurred at 0.215V and no other anodic peaks were observed.

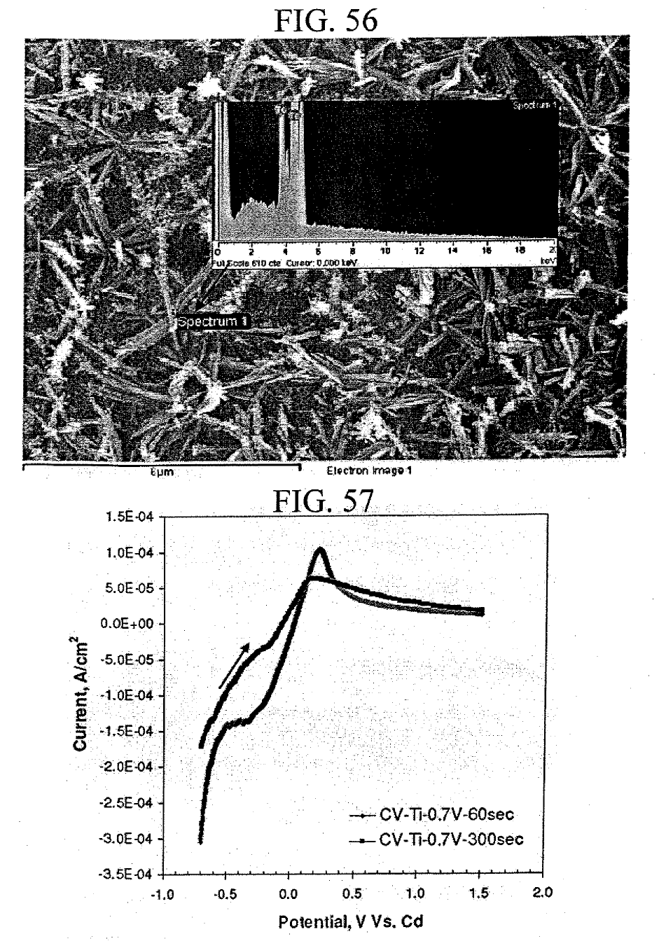

When the potential was switched at 0.3V, only Te deposition was observed as shown in FIG. 56. In porous surface, initially the deposition takes place deep inside the nanopores. During anodic sweep, the material deposited on the surface dissolves (strips first) followed by the dissolution of the material inside the pores. Therefore, for the sample with −0.7V switching potential (FIG. 54), material deposited at more negative potentials dissolved first showing a peak. The dissolved species could be predominantly tellurides of Cd and Zn. As tellurium deposited first within the nanopores, its dissolution as tellurium species was not observed till the potential was more positive than 0.9V with some over potential.

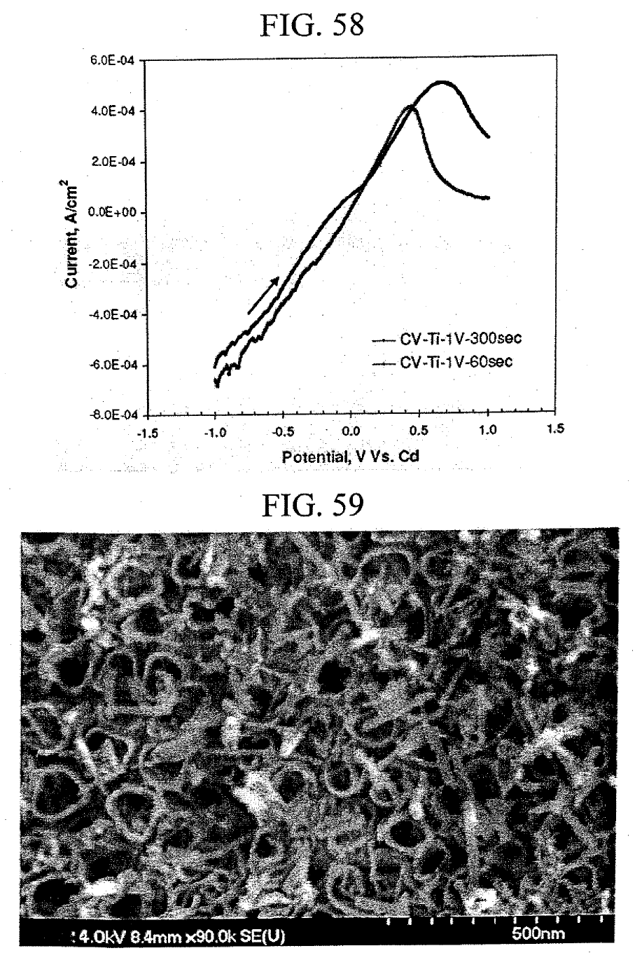

The observations are further supported by considering the anodic scans after different holding times at different constant cathodic potentials in CdZnTe solution. FIG. 57 illustrates the anodic stripping characteristic of film deposited on TiO₂ at −0.7V at different times. With increase in holding time the anodic peak current decreased and the corresponding peak potentials shifted to less positive potentials. This increased peak current at shorter holding time could be attributed to the adhesion characteristics of the deposited film. It is possible that when the potential was maintained for longer time the adsorbed species rearrange to form a better adhered film. In general, Ti substrate is considered to be superior for electrodeposition of a CdZn chalcogenide thin film, or other Group 12-16 chalcogenide thin films, because of better adhesion properties. Otherwise, observations of thermal evaporation of CdZnTe thin film indicated very low sticking coefficient of Zn. Zn has been observed to have low low adsorption characteristics in aqueous solutions. Thus, lower cathodic potential (−0.7 V) may require longer holding times for better adhesion characteristics. Further, occurrence of anodic current at negative potentials with increased holding time indicates stripping of Zn or ZnTe. Typical composition of the film deposited at −0.7 V was 43% Cd, 3% Zn and balance Te. Whereas the film deposited at −1.0 V showed increased Zn content (˜20%) and less Cd (˜30%). FIG. 58 shows the anodic stripping characteristic of the film deposited at −1.0 V with different holding times. At more negative potentials, increased holding time increased the anodic peak current and shifted the peak potential to more positive values. Occurrence of a single large anodic peak and anodic peak potential shift to noble values could be attributed to the formation of a uniform CdZnTe film at more negative potentials. Chemical analysis of thin films (using energy dispersive X-ray analysis) deposited from non-aqueous solutions during CV tests and potential pulse depositions showed uniform presence of Zn content. These results are discussed later in the following sections. The reason for uniform stoichiometry of CdZnTe could be attributed to the characteristic of propylene carbonate (PC) solvent. In this electrolyte the difference in reduction potentials of Cd and Zn were observed to be much smaller than that observed in aqueous solutions. Table 4 illustrates the open circuit potentials of pure Cd and Zn wires immersed in 5 mM and 10 mM concentrations of their chloride salt solutions (both aqueous and PC) measured with reference to a standard Ag/AgCl electrode. It can be observed that in PC solution the reduction potential of Cd²⁺/Cd was about 0.2 V positive as compared to the value observed in aqueous solution. Similar results were reported for lithium ions in PC. In addition, the addition of acetonitrile solution to aqueous salt solution of CdZnTe may result in a merger of the reduction current peaks of Te, Cd and Zn species. In this study, the reduction potentials of Cd and Zn were only about 100 mV apart in stead of the reported 360 mV difference in aqueous solutions for similar concentrations. Further, concentration of chloride also played a role in determining the potentials according to Nerst equation.

TABLE 4
Comparison of Reference Electrode Potentials in Aqueous and Propylene
Carbonate Media with Reference to Ag/AgCl at 95° C.

| | Potential measured with | Potential measured with |
|---|---|---|
| | Cd wire immersed in 5x | Zn wire immersed in 10x |
| | 10⁻³ M CdCl₂ with | 10⁻³ M ZnCl₂ with |
| Solution Media | reference to Ag/AgCl | reference to Ag/AgCl |
| Aqueous solution | −620 | −942 |
| Propylene | −425 | −510 |
| Carbonate | | |

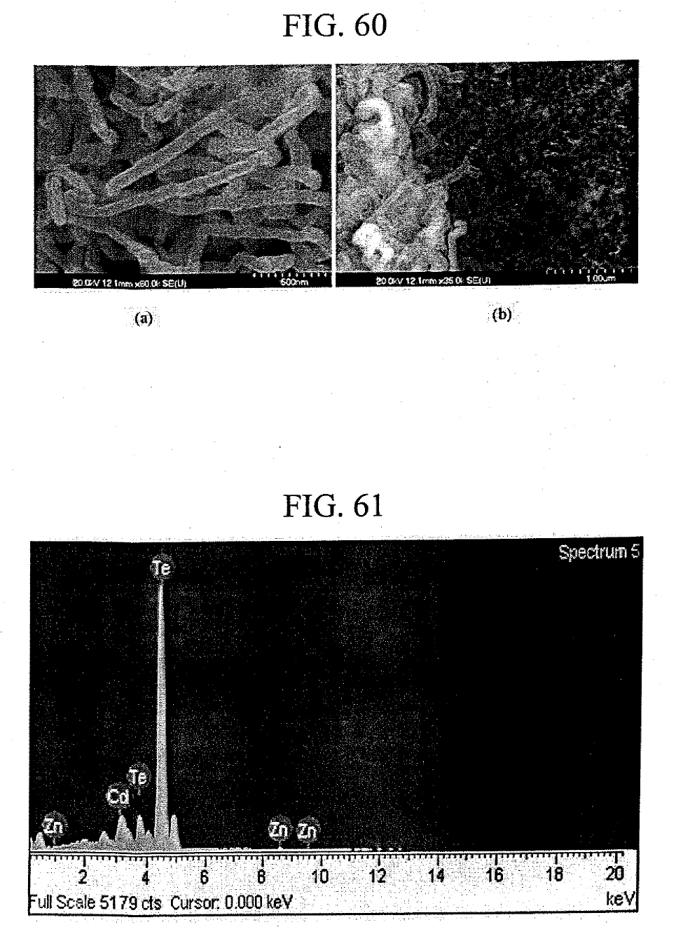

FIG. 59 shows the growth of nanowires of CdZnTe from the anodized titanium dioxide templates after 1 minute of deposition. The two cathodic deposition potential used in this case was −0.4V for 1 Sec and −0.6 V for 1 sec. FIG. 60 shows the Nanowires of CdZnTe after 30 minutes of deposition. From this figure it can be noticed that the diameter of the nanowires varied from 50-100 nm and the length varied from 1 to 2 μm. It was observed that the wire growth was initially straight from the nanopores of the template, and eventually the wires became entangled with increase in deposition time.

FIG. 61 shows the EDAX analysis done on the −0.4 V for 1 sec, −0.6V for 1 sec samples. The composition of the nanowires as determined from the EDAX corresponded to Cd_{0.96}Zn_{0.04}Te compound. Table 5 shows the compositions of CdZnTe nanowires obtained at different deposition conditions. Only the cathodic potentials were varied and other parameters such as anodic potentials and pulse time for each potential step were kept as constants. From the table it is seen that when the cathodic potential becomes more negative it results in the deposition of more zinc, where as when the deposition potential is less negative it results in the deposition of more cadmium and less tellurium.

TABLE 5
Comparison of Chemical Composition of CZT
Obtained at Different Cathodic Potentials.

| | Cadmium | Zinc | Tellurium |
|---|---|---|---|
| Cathodic Potential | composition | composition | composition |
| Applied | in atomic % | in atomic % | in atomic % |
| −0.4 V for 1 Sec, | 43-45 | 2-5 | 50-55 |
| −0.6 V for 1 sec | | | |
| −0.35 V for 1 sec, | 44-45 | 3-5 | 53-55 |
| −0.65 V for 1 sec | | | |
| −0.6 V for 1 sec, | 30-35 | 10-13 | 50-52 |
| −0.7 V for 1 sec | | | |
| −0.4 V for 1 sec, | 49-50 | 1-2 | 49-50 |
| −0.5 V for 1 sec | | | |
| −1.0 V for 1 sec, | 33-34 | 22-23 | 43-45 |
| −1.2 V for 1 sec | | | |

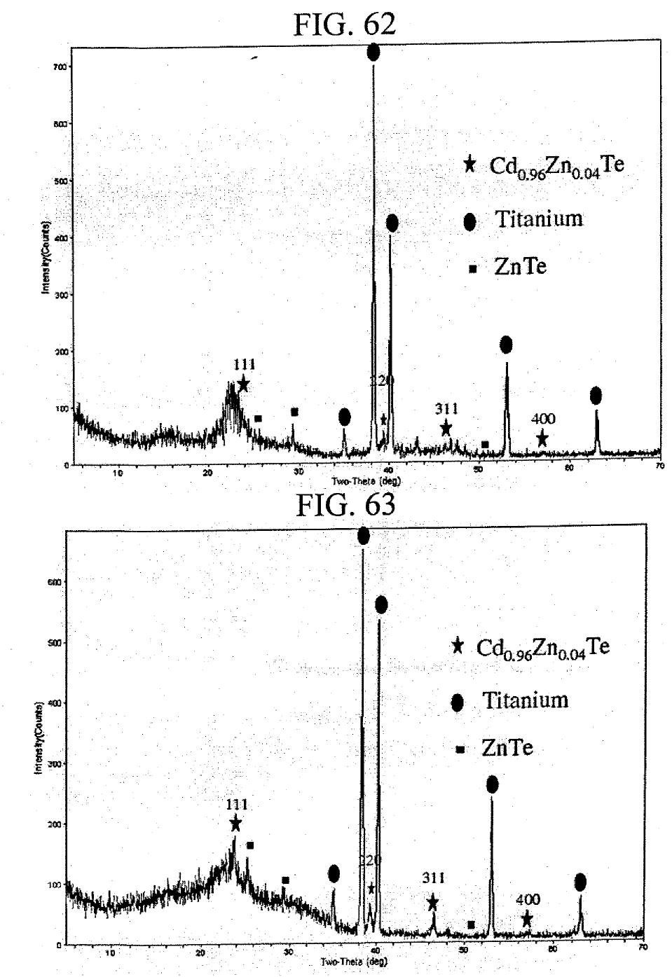

The nanowires deposited were analyzed by XRD in as deposited as well as annealed condition. FIG. 62 shows a typical XRD result of CdZnTe nanowire deposit revealing Cd_{0.96}Zn_{0.04}Te stoichiometry in as-deposited condition. FIG. 63 shows the XRD peaks after annealing in argon at 350° C. for 1 hr. In the annealed conditions the CdZnTe peaks show up more prominently when compared to the as deposited condition. This could be attributed to the more crystalline nature of the annealed film. Further, ZnTe peaks also became sharper after annealing indicating co-existence of this compound.

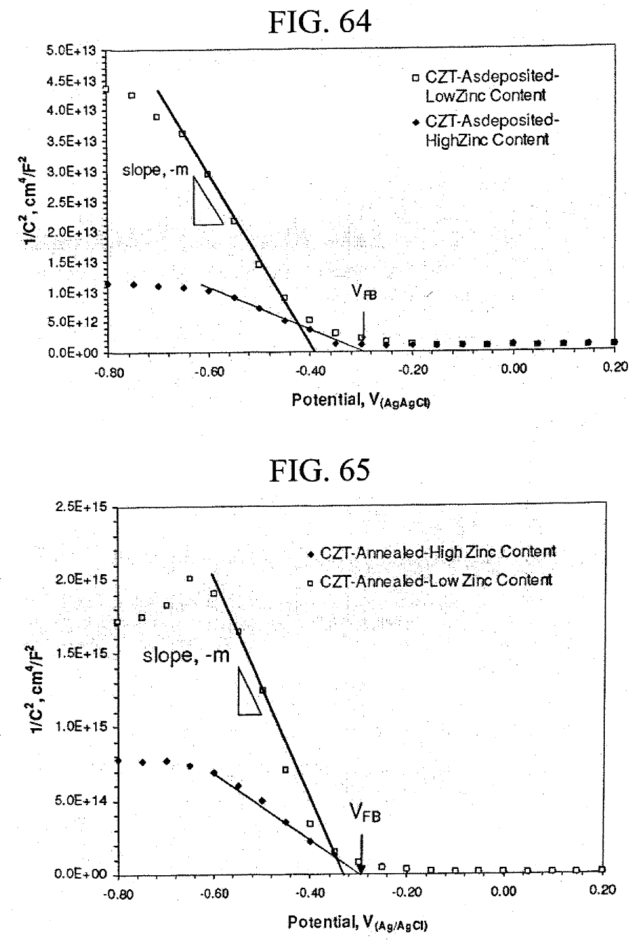

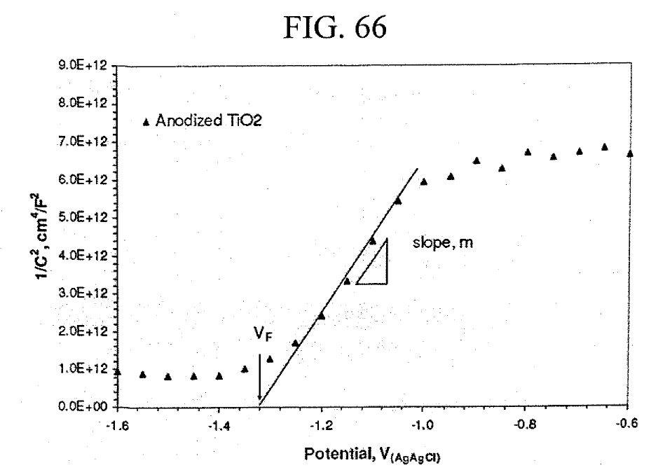

FIGS. 64 and 65 show the Mott-Schottky plots of the CdZnTe nanowire deposits in the as-deposited and annealed conditions respectively. 2% Zn content is referred as low zinc samples and 10% Zn are referred as high. All deposits contained about 50% Te and balance was Cd. Irrespective of the Zn content and thermal treatment condition p-type semiconductivity was observed from the Mott-Schottky plots (negative slope). p-type semiconductivity has been reported for Cd₁₋ₓZnₓTe semiconductors when x>0.07 by other investigators. Those investigations were carried out on CdZnTe crystals grown by Bridgman method and when x=0.04, n-type semiconductivity was observed. In this present investigation, Cd_{0.96}Zn_{0.04}Te also indicated p-type semiconductivity. Transition in type of semiconductivity was attributed to the increase in Cd vacancies and presence of ionized Te atoms located in Cd vacancies as Te⁺_{Cd} or Te²⁺_{Cd}. In this investigation, both cathodic and anodic potentials were applied for controlled growth of nanowires. Application of anodic potentials such as 0.7 and 0.3 V resulted in dissolution of species, particularly Cd. Observations of CV indicated that at 0.3 V, Te could still be reduced. Therefore, it is possible that at anodic potentials Cd dissolved creating Cd vacancies and these vacancies could have been occupied by Te, inducing conditions for p-type conductivity. Table 6 summarizes the flat band potential and the charge density data of the samples. As-deposited samples showed higher charge densities indicating higher defect concentration. Thermal annealing caused annihilation of possible surface and point defects resulting in decrease in charge carrier densities, in the order of 10¹⁵ cm⁻³. Flat band potentials were not significantly affected by the thermal treatment conditions. More negative flat band potentials were observed with lower zinc content. The charge carrier density increased with increase in Zn content. As the charge carriers in p-type materials are holes or metal ion vacancies, increased carried density implies increased Cd vacancies with increase in Zn content. It is well documented that for high resistivity CdZnTe material, the shallow level donors and acceptors should be well compensated and the Fermi level should be pinned at the center of the band gap. This condition is generally achieved by controlled doping of donors such as indium, aluminum etc, and acceptors such as Cl, N, P etc. It is possible to control the resistivity of CdZnTe deposits without doping also by electrochemically controlling the densities of Cd vacancies and singly ionized Te antisites as these are shallow acceptors and donors respectively. By modulating the cathodic and anodic potentials and pulsing times CdZnTe nanowires with very high electric resistance could be achieved, which will be the focus of extension of this investigation. FIG. 66 shows the Mott-Schottky plot for the nanoporous TiO₂ template in as-anodized condition. The template showed showed n-type semiconductivity which is a typical behavior of TiO₂. The flat band potential of TiO₂ in pH=2.0 is observed to be more negative as compared to the CdZnTe samples.

TABLE 6
Showing the Flat Band Potential and the
Charge Density for CZT and TiO₂ samples.

| | Flat band | Charge |
|---|---|---|
| | Potential, | Density, |
| Sample Condition | V Vs. Ag/AgCl | cm⁻³ |
| CZT as-deposited, low zinc content | −0.39 | 8.59 × 10¹⁶ |
| CZT as-deposited, high zinc content | −0.29 | 3.26 × 10¹⁷ |
| CZT annealed, low zinc Content | −0.33 | 1.56 × 10¹⁵ |
| CZT annealed, high zinc Content | −0.29 | 5.05 × 10¹⁵ |
| Anodized TiO2 | −1.32 | 8.09 × 10¹⁶ |

### Example 21

### Optical Absorption of Nanotubular TiO₂ Arrays Anodized in a Phosphate Solution

FIG. 67 shows the optical absorption spectra of nanotubular TiO₂ arrays anodized in a 0.5 M H₃PO₄+0.14 M NaF (i.e. phosphate) solution. The annealed specimen (annealed at 350° C. for 6 h in a nitrogen atmosphere) showed a 30 nm red shift of absorption peak as compared to the as-anodized sample. Annealing either in an inert N₂) or in a reducing (H₂) atmosphere resulted in similar optical absorption characteristics. Anodization in nitrate containing solutions may also result in adsorbed nitrogen species on the nanotubular structure and create surface states. FIG. 68 shows a typical N 1 s XPS spectrum of the TiO₂ nanotubular sample anodized in nitrate solution and annealed in nitrogen atmosphere. Only a molecularly chemisorbed nitrogen peak at 400 eV was observed. A very faint peak at 396 eV associated with Ti—N bonding could be observed that indicated incorporation of nitrogen species in the TiO₂.

Thus, It was observed that samples anodized in phosphate solutions showed relatively better optical absorption as compared to the samples anodized in nitrate solutions. It is envisaged that anodization in 0.5 M H₃PO₄+0.14 M NaF solution results in adsorption of phosphate ions at the outer walls of the TiO₂ nanotubes and subsequent annealing in low oxygen pressure could cause diffusion of phosphorous species in the TiO₂ lattice creating sub-band gap or surface states. FIG. 69 shows the high resolution P 2 p XPS spectrum and the peak at 133.8 eV indicates incorporation of phosphorous species in the TiO₂ nanotubes.

What is claimed is:

1. A method of making a nanotubular titania substrate having a titanium dioxide surface comprised of a plurality of vertically oriented titanium dioxide nanotubes containing oxygen vacancies, the method comprising the steps of
anodizing a titanium metal substrate in an acidified fluoride electrolyte under conditions sufficient to form a titanium oxide surface comprised of self-ordered titanium oxide nanotubes, and
annealing the titanium oxide surface in a non-oxidating atmosphere.

2. The method of claim 1, wherein the non-oxidating atmosphere is a reducing atmosphere.

3. The method of claim 2, wherein the reducing atmosphere is an atmosphere comprising at least one of nitrogen, hydrogen, and cracked ammonia.

4. The method of claim 1 further comprising the step of doping the titanium oxide surface with a Group 14 element, a Group 15 element, a Group 16 element a Group 17 element, or mixtures thereof.

5. The method of claim 1, wherein the electrolyte includes a fluoride compound selected from the group consisting of HF, LiF, NaF, KF, NH₄F, and mixtures thereof.

6. The method of claim 1, wherein the electrolyte is an aqueous solution.

7. The method of claim 1, wherein the electrolyte is an organic solution.

8. The method of claim 7, wherein the organic solution is a polyhydric alcohol selected from the group consisting of glycerol, EG, DEG, and mixtures thereof.

9. The method of claim 1, wherein the electrolyte is ultrasonically stirred.

10. A nanotubular titania substrate having an annealed titanium dioxide surface comprised of self-ordered titanium dioxide nanotubes containing oxygen vacancies.

11. The nanotubular titania substrate of claim 10 having a band gap ranging from about 1.9 eV to about 3.0 eV.

12. The nanotubular titania substrate of claim 10, wherein the titanium dioxide nanotubes are doped with a Group 14 element, a Group 15 element, a Group 16 element, a Group 17 element, or mixtures thereof.

13. The nanotubular substrate of claim 10, wherein the titanium dioxide nanotubes are nitrogen doped.

14. The nanotubular substrate of claim 10, wherein the titanium dioxide nanotubes are carbon doped.

15. The nanotubular substrate of claim 10, wherein the titanium dioxide nanotubes are phosphorous doped.

16. The nanotubular substrate of claim 10, wherein the titanium dioxide nanotubes are doped in at least two of carbon, nitrogen, and phosphorous.

17. The nanotubular substrate of claim 10, wherein the titanium dioxide nanotubes are further modified with carbon under conditions suitable to form carbon modified titanium dioxide nanotubes.

18. A photo-electrochemical cell having the nanotubular titania substrate of claim 10 as an electrode.

19. A photo-electrolysis method for generating H₂ comprising the step of irradiating a photo-anode and a photo-cathode with light under conditions suitable to generate H₂,
wherein the photo-anode is a nanotubular titania substrate of claim 10.

20. The photo-electrolysis method of claim 19, wherein the light is solar light.

21. The photo-electrolysis method of claim 19, wherein an acidic solution is used in the photo-cathode compartment.

22. The photo-electrolysis method of claim 19, wherein a basic solution is used in the photo-anode compartment.

23. The photo-electrolysis method of claim 19, wherein the photo-cathode is at least one substance selected from the groups consisting of a cadmium telluride (CdTe) coated platinum foil, a cadmium zinc telluride (CdZnTe) coated platinum foil, and anodized TiO₂ nanotubes coated with nanowires of CdTe or CdZnTe.

24. An electrochemical method of synthesizing CdZn or CdZnTe nanowires comprising pulsing cathodic and anodic potentials to grow the nanowires, wherein a nanoporous TiO₂ template was used in combination with non-aqueous electrolyte.

25. The method of claim 24, wherein the non-aqueous electrolyte is propylene carbonate.

26. A nanotubular titania substrate having CdTe or CdZnTe nanowires extending therefrom.
